(19) United States
(12) Patent Application Publication
(10) Pub. No.: US 2008/0024659 A1
(43) Pub. Date: Jan. 31, 2008

(54) Video signal processing apparatus and video signal processing method

(75) Inventor: Kenta Tanaka, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/827,663

(22) Filed: Jul. 11, 2007

(30) Foreign Application Priority Data
Jul. 14, 2006 (JP) P2006-194095

(51) Int. Cl. H04N 7/01

(52) U.S. Cl. 348/452; 348/E05.109

(57) ABSTRACT

Upon receiving video signal data in a plurality of formats, a video signal processing apparatus may convert the video signal data into transmission video signal data synchronized with clocks having a fixed frequency common to the plurality of formats, in which the number of clocks corresponding to one frame determined according to the frequency of the clocks may be the same regardless of the plurality of formats of the video signal data. A frame reference signal may be inserted in each frame of the transmission video signal data to specify a predetermined reference data position in the frame. The transmission video signal data having the frame reference signals inserted therein may be output in synchronization with the clocks on a frame-by-frame basis. The transmission video signal data may be converted into a desired video signal format and then outputted in synchronization with frame period timings generated on the basis of the frame reference signals.

### CROSS-REFERENCE TO RELATED APPLICATIONS

This application claims priority from Japanese Patent Application No. JP 2006-194095 filed in the Japanese Patent Office on Jul. 14, 2006, the entire content of which is incorporated herein by reference.

### BACKGROUND OF THE INVENTION

1. Field of the Invention

The present invention relates to a video signal processing apparatus and a method therefor in which signal processing including data transmission is performed on a digital video signal (video signal data).

2. Description of the Related Art

In general, there are known two types of television signal formats: Standard Definition (SD) and High Definition (HD).

SD is a standard format previously known in the art, such as the National Television Standards Committee (NTSC) format in which it is specified that the number of horizontal lines is 525. HD is a format developed and standardized after SD for the purpose of achieving a higher-level format, such as higher image quality, than SD. For example, in the NTSC system, it is specified that the number of horizontal lines for the HD format is 1080.

Recently, there have become available consumer portable video camera apparatuses configured such that moving image signals obtained by image capture can be recorded onto recording media in the HD format. Such HD-compatible video camera apparatuses allow even general users to easily record and store high-quality captured images.

One of such video camera apparatuses is disclosed in Japanese Unexamined Patent Application Publication No. 2006-1088556.

### SUMMARY OF THE INVENTION

In general, many peripheral AV devices are still only SD-compatible. The data size of HD video data per unit time is considerably larger than that of SD video data. Therefore, users of HD-compatible video camera apparatuses may desire to use HD and SD modes for image capturing and recording depending on the photographic conditions and the like to make efficient use of the capacity of storage media while enjoying high-quality HD video.

In the context of such a situation, generally, current HD-compatible video camera apparatuses are actually designed to be “backward compatible” to also achieve functions substantially equivalent to those of typical SD-compatible video camera apparatuses, such as image capturing and recording in the SD format.

Such HD-compatible video camera apparatuses backward compatible with the SD format are capable of recording and playback in both HD and SD formats. In this case, the following problems may arise.

In general, video camera apparatuses are designed to play back captured image data stored in storage media and to display images on display units thereof or convert the captured image data into a predetermined video signal format before outputting it from predetermined video signal output terminals to the outside. HD-compatible video camera apparatuses also have such functions as displaying images on display units thereof or outputting video signals. However, due to the compatibility with both HD and SD formats, there may be occasions when the original video source (video signal data format) of images being displayed on the display units or video signals being outputted may be switched from HD to SD or, conversely, from SD to HD.

However, the HD and SD formats are basically different from each other in properties such as the video signal processing clock or data structure within a frame. If the video source is simply switched between HD and SD at the timing when a video source switching instruction is received, the vertical synchronization timings of the video source are deviated before and after the switching. As a result, for example, the image being displayed may be distorted. It is desirable to avoid such image distortion for, for example, improved and sustained product quality of video camera apparatuses.

According to an embodiment of the present invention, there is provided a video signal processing apparatus which may include the following elements.

Upon receiving video signal data for which format switching can occur between a plurality of formats, format converting means may convert the video signal data into transmission video signal data, the transmission video signal data being formatted such that the transmission video signal data is synchronized with clocks having a fixed frequency common to the plurality of formats and that the number of clocks corresponding to one frame determined according to the frequency of the clocks is the same regardless of the plurality of formats of the video signal data. Frame reference signal inserting means may insert a frame reference signal in each frame of the transmission video signal data obtained by the format converting means to specify a predetermined reference data position in the frame. Transmission output processing means may transmit and output the transmission video signal data having the inserted frame reference signals in synchronization with the clocks on a frame-by-frame basis. Upon receiving the transmission video signal data transmitted and output by the transmission output processing means, signal output processing means may perform signal processing for converting the transmission video signal data into a desired video signal format and outputting the converted transmission video signal data, wherein the signal processing may be performed in synchronization with frame period timings generated on the basis of the frame reference signals inserted in the received transmission video signal.

The present invention further provides a video signal processing apparatus which may include the following elements.

Upon receiving video signal data for which format switching can occur between a plurality of formats, format converting means may convert the video signal data into transmission video signal data, the transmission video signal data being formatted such that the transmission video signal data is synchronized with clocks having a fixed frequency common to the plurality of formats and that the number of clocks corresponding to one frame determined according to the frequency of the clocks is the same regardless of the plurality of formats of the video signal data. Frame reference signal inserting means may insert a frame reference signal in each frame of the transmission video signal data obtained by the format converting means to specify a predetermined reference data position in the frame. Transmission output processing means may transmit and output the transmission video signal data having the inserted frame reference signals to another apparatus in synchronization with the clocks on a frame-by-frame basis.

The present invention further provides a video signal processing apparatus which may include the following elements.

Inputting means may input transmission video signal data transmitted and output from another apparatus, the transmission video signal data being generated by converting video signal data for which format switching can occur between a plurality of formats, the transmission video signal data being formatted such that the transmission video signal data may be synchronized with clocks having a fixed frequency common to the plurality of formats and that the number of clocks corresponding to one frame determined according to the frequency of the clocks may be the same regardless of the plurality of formats of the video signal data, the transmission video signal data having a frame reference signal inserted in each frame thereof to specify a predetermined reference data position in the frame. Signal output processing means may perform signal processing for converting the transmission video signal data input by the inputting means into a desired video signal format and outputting the converted transmission video signal data, wherein the signal processing may be performed in synchronization with frame period timings generated on the basis of the frame reference signals inserted in the input transmission video signal data.

According to the above-described embodiments of the present invention, the video signal processing apparatus may receive video signal data for which format switching can occur between a plurality of formats, and generate transmission video signal data. The transmission video signal data may be formatted such that the transmission video signal data is synchronized with clocks having a fixed frequency common to the plurality of formats and that the number of clocks for one frame determined according to the frequency of the clocks (one clock corresponds to one clock cycle: the number of clocks may therefore mean the number of clock cycles) may be constant regardless of the plurality of formats. Further, a frame reference signal may be inserted in each frame of the transmission video signal data to specify a reference data position in that frame. The transmission video signal data having the frame reference signal inserted therein may be transmitted and output as sequences in units of frame in synchronization with the clocks.

A section that performs signal processing on the transmitted and output transmission video signal data may perform signal processing for converting the transmission video signal data into a predetermined video signal format and outputting the resulting signal in synchronization with frame period timings generated on the basis of the frame reference signals.

With the above-described structure, the transmission video signal data may be transmitted with continuity of frames regardless of whether or not format switching occurs when the original video signal data is input. The section that performs signal processing on the transmission video signal data may use the frame reference signals inserted in the transmission video signal data to maintain stable frame period timings (vertical synchronization timings) with constant intervals regardless of whether or not format switching occurs when the original video signal data is input, and may perform the signal processing at the frame period timings. As a result, for example, a video signal output through the above-described signal processing can be stable without deviation in vertical synchronization timings even if the format has been changed during the signal processing.

Accordingly, a video signal output with constant frame intervals can be achieved regardless of whether or not format switching of video signal data occurs. Therefore, for example, when an image is displayed using the video signal output, the image may not be distorted at the timing when the format of the video signal data is changed, resulting in a normal image display. For example, product reliability can be improved.

### BRIEF DESCRIPTION OF THE DRAWINGS

FIG. 1 is a diagram showing an example structure of a video camera apparatus according to an embodiment of the present invention;

FIGS. 2A and 2B are diagrams showing a data array of Y, Cb, and Cr components in an example HD-source baseband data format;

FIGS. 3A and 3B are diagrams showing a data array of Y, Cb, and Cr components in an example SD-source baseband data format;

FIGS. 4A and 4B are diagrams showing a horizontal line structure in one frame specified in the HD- and SD-source baseband data formats under the NTSC system, respectively;

FIGS. 5A and 5B are diagrams showing a horizontal line structure in one frame specified in the HD- and SD-source baseband data formats under the PAL system, respectively;

FIG. 6 is a diagram showing a baseband data transmission format for NTSC-HD sources;

FIG. 7 is a diagram showing a baseband data transmission format for NTSC-SD sources;

FIG. 8 is a diagram showing a baseband data transmission format for PAL-HD sources;

FIG. 9 is a diagram showing a baseband data transmission format for PAL-SD sources;

FIG. 10 is a diagram showing an example definition of EAV and SAV codes;

FIG. 11 is a diagram showing an example insertion of a frame reference signal according to the present embodiment;

FIG. 12 is a diagram showing an example internal structure of a main signal processing unit in the video camera apparatus shown in FIG. 1;

FIG. 13 is a timing chart showing an example of the operation of the main signal processing unit;

FIG. 14 is a diagram showing an example internal structure of a display-output-system signal processing unit in the video camera apparatus shown in FIG. 1;

FIG. 15 is a timing chart showing a demultiplexing process compatible with HD sources performed by the display-output-system signal processing unit;

FIG. 16 is a timing chart showing a demultiplexing process compatible with SD sources performed by the display-output-system signal processing unit; and

FIG. 17 is a timing chart showing an example of the operation of the display-output-system signal processing unit.

### DETAILED DESCRIPTION

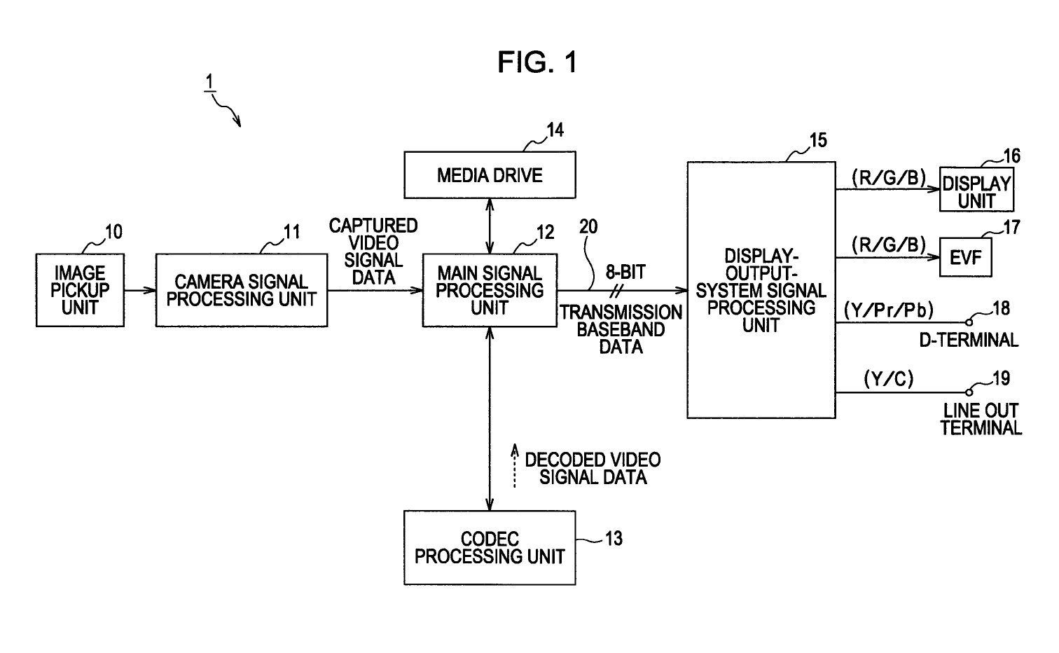

FIG. 1 shows an example of the overall structure of a video camera apparatus 1 according an embodiment of the present invention. The video camera apparatus 1 is implemented as a video (image) signal processing apparatus according to an embodiment of the present invention, including the following elements.

An image pickup unit 10 at least includes an optical system section having optical system components such as an imaging lens group and a diaphragm, and a photoelectric conversion section having an image pickup element. In the optical system section, incident light is focused as image pickup light onto a light-receiving surface of the image pickup element in the photoelectric conversion section. The photoelectric conversion section includes a photoelectric conversion element such as a complementary metal-oxide semiconductor (CMOS) sensor or a charge coupled device (CCD) sensor. The photoelectric conversion section converts the image pickup light entering from the optical system section and focused onto the light-receiving surface into an electrical signal to generate an image pickup signal, and outputs the image pickup signal to a camera signal processing unit 11.

The camera signal processing unit 11 performs waveform shaping on the analog image pickup signal input from the photoelectric conversion section of the image pickup unit 10 by performing, for example, gain adjustment and sample-and-hold processing, and then converts the analog image pickup signal into a digital video signal (video signal data). The converted video signal data is output to a main signal processing unit 12.

The video signal data input from the camera signal processing unit 11 to the main signal processing unit 12 may also be hereinafter referred to as “captured video signal data” to distinguish it from video signal data input from a codec processing unit 13 to the main signal processing unit 12, as described below. The video signal data input from the codec processing unit 13 to the main signal processing unit 12 is hereinafter referred to as “decoded video signal data.”

The main signal processing unit 12 is configured so as to perform main video signal processing in the video camera apparatus 1, such as predetermined video signal processing and signaling control to be performed until the captured video signal data input from the camera signal processing unit 11 is stored in a medium.

The video camera apparatus 1 of the present embodiment is also configured such that moving images can be recorded and played back in both SD and HD video signal formats under a predetermined color television system.

As previously described, SD is a standard format practically available prior to HD, such as the NTSC format in which 525 horizontal lines (i.e., 525 vertical pixels) are specified, or the Phase Alternation Line (PAL) standard in which 625 horizontal lines are specified. HD is a signal format practically available after SD, and achieves higher image quality than SD. For example, higher resolutions (the number of horizontal/vertical pixels) are specified.

Therefore, for example, the main signal processing unit 12 is configured so as to perform various types of signal processing compatible with either HD or SD signal format to support both HD and SD signal formats.

The video camera apparatus 1 of the present embodiment is compatible with the HD and SD signal formats under NTSC or PAL television system. However, the television system used in the present invention is not specifically limited thereto, and any other television system such as the Sequential Couleur Avec Memoire (SECAM) standard may be used.

Upon receiving the captured video signal data from the camera signal processing unit 11 in the manner described above, the main signal processing unit 12 performs processing such as conversion into a signal format suitable for compression encoding, as necessary, and transfers the resulting captured video signal data to the codec processing unit 13.

The codec processing unit 13 is configured so as to perform signal processing for the video signal data, at least including compression encoding processing compatible with either SD or HD format and decoding (decompression) corresponding to the compression encoding. Known compression encoding schemes compatible with both HD and SD formats include, but are not limited to, MPEG-2 (Moving Picture Experts Group 2). MPEG-4 AVC/H.264 is another known scheme compatible with the HD format. Any of those schemes can be used in the present embodiment.

The codec processing unit 13 is also configured so as to perform compression encoding on the video signal data transferred from the main signal processing unit 12 according to the compression encoding scheme compatible with the specified format (HD or SD). In the structure shown in FIG. 1, for example, the encoded data obtained by the compression encoding processing is received again by the main signal processing unit 12, and is further transferred to a media drive 14 as recording data.

The media drive 14 is a drive device for writing and reading data to and from a predetermined type of storage medium that is built-in or removable from the video camera apparatus 1. Examples of the built-in media (storage media) supported by the media drive 14 include, but are not limited to, a hard disk. Examples of the removable media supported by the media drive 14 include, but are not limited to, optical disc-shaped recording media such as various types of digital versatile discs (DVDs), and various memory devices including semiconductor storage elements such as flash memories.

Upon receiving recording data in the manner described above, the media drive 14 writes the recording data to a storage medium for storage. Accordingly, the video camera apparatus 1 of the present embodiment can store information of a moving image obtained by image capture in the storage medium. The moving image information stored in the storage medium is managed on a file-by-file basis according to a predetermined file system specified according to, for example, the type of the storage medium.

The video camera apparatus 1 of the present embodiment is also configured to read the moving image information stored in the medium and to play back and display the image associated with the read moving image information using a display section including a display unit 16 and an electronic viewfinder (EVF) 17. The video camera apparatus 1 further includes a D-terminal 18 and a LINE OUT terminal 19 as signal output terminals compatible with predetermined video signal formats to convert the read moving image information into a desired signal format, and outputs the resulting signals from those signal output terminals to the outside.

In this case, first, data as the moving image information stored in the medium is read by the media drive 14. The media drive 14 transfers the read data to the main signal processing unit 12.

The data output from the media drive 14 is compression-encoded video signal data. The data output from the media drive 14 is transferred by the main signal processing unit 12 to the codec processing unit 13 for decoding.

The codec processing unit 13 decodes (decompresses) the received moving image information data according to the compression encoding method to obtain video signal data of the original format before the compression encoding, and transfers the obtained signal data to the main signal processing unit 12.

Upon receiving the video signal data (decoded video signal data) transferred from the codec processing unit 13, for example, the main signal processing unit 12 converts the received video signal data into a predetermined signal format suitable for a baseband data conversion process, as necessary, and performs signal processing for further conversion into baseband data (baseband signal) of the predetermined format before the compression encoding.

In the present embodiment, for example, the main signal processing unit 12 and a display-output-system signal processing unit 15 are actually mounted as separate large scale integration (LSI) components. In practice, the transmission of video signals between the main signal processing unit 12 and the display-output-system signal processing unit 15 is performed according to a predetermined inter-device video signal transmission standard. In the present embodiment, CCIR Rec. 656, which is a parallel transmission standard, is used as the inter-device video signal transmission standard, and signal transmission complying with CCIR Rec. 656 is performed.

In inter-device video signal transmission standards such as CCIR Rec. 656, data transmission is generally performed in baseband data formats complying with the transmission standards rather than in compression-encoded formats. The main signal processing unit 12 performs the above-described conversion into baseband data to obtain baseband data in a CCIR Rec. 656 compatible format. The main signal processing unit 12 outputs the resulting baseband video signal data (baseband data) to the display-output-system signal processing unit 15.

Since CCIR Rec. 656 is a parallel transmission standard, in the present embodiment, parallel transmission is performed over a transmission channel 20 between the main signal processing unit 12 and the display-output-system signal processing unit 15. The parallel transmission channel 20 has a capacity of 8 bits, the reason of which is described below. The 8-bit parallel transmission channel 20 is hereinafter also refereed to as a “display-output-system transmission channel 20.” The data transmitted from the main signal processing unit 12 to the display-output-system signal processing unit 15 via the display-output-system transmission channel 20 is hereinafter referred to as “transmission baseband data.”

The display-output-system signal processing unit 15 is configured such that, first, display video signal data for allowing the display unit 16 and the viewfinder 17 to perform image display can be generated on the basis of a video signal in a predetermined format inputted as the transmission baseband data via the display-output-system transmission channel 20 and can be output. The display-output-system signal processing unit 15 is also configured such that video signal data for color image display in a predetermined signal format can be output from the D-terminal 18 and the LINE OUT terminal 19.

It is assumed that the display unit 16 and the viewfinder 17 include display devices implemented as liquid crystal displays (LCDs). When an image is displayed using the display unit 16 or the viewfinder 17, the display-output-system signal processing unit 15 converts the input baseband data into display video signal data of a color image display format in accordance with the number of pixels corresponding to the size (resolution) of the LCD serving as the display unit 16 or the viewfinder 17. The display unit 16 and the viewfinder 17 are driven by the display video signal data to display an image. Therefore, for example, the image associated with the moving image information read from the medium is displayed on a display screen of the display unit 16 or the viewfinder 17.

In accordance with a signal output from the D-terminal 18, the display-output-system signal processing unit 15 converts the input baseband data into Y/Pb/Pr component signal data complying with a predetermined D-terminal standard.

In accordance with a signal output from the LINE OUT terminal 19, the display-output-system signal processing unit 15 converts the input baseband data into an analog Y and C (Y/C) composite signal or separate signal format.

Accordingly, the display-output-system signal processing unit 15 is configured so as to perform signal processing related to the image display on the display section (the display unit 16 and the viewfinder 17) in the video camera apparatus 1 and perform signal processing for obtaining video signals to be output from the external signal output terminals (the D-terminal 18 and the LINE OUT terminal 19).

The video signals output from the external signal output terminals are typically used for another apparatus connected to the terminals via cables or the like to display images. Therefore, the signal processing related to display output include, not only the conversion into a video signal format to display an image on the display section (the display unit 16 and the viewfinder 17), but also the conversion into video signal formats to output the converted video signals from the external signal output terminals (the D-terminal 18 and LINE OUT terminal 19), which is performed by the display-output-system signal processing unit 15. As indicated by name, the display-output-system signal processing unit 15 is a section that performs signal processing for the display output system.

During the actual moving image recording and playback operations of the video camera apparatus 1, for example, information regarding sound picked up by a microphone or the like together with captured images is also generally recorded and played back in synchronization with the moving images. In FIG. 1, however, a structure for recording and playing back sound (audio signal) in synchronization with the moving image information is omitted for ease of illustration. In general, video camera apparatuses are capable of recording and playing back captured images including both moving images and still images. Hence, the video camera apparatus 1 of the present embodiment may also be configured to record still image data obtained by image capture onto a medium and to play back the still image data.

As described above with reference to FIG. 1, the video camera apparatus 1 of the present embodiment can record and play back captured image data compatible with both HD and SD signal formats under the NTSC or PAL system. That is, the video camera apparatus 1 of the present embodiment is configured so as to perform recording and playback signal processing for video sources (video signal sources) of both HD and SD signal formats. The term video source as used herein means image information (video signal data) input from the image pickup unit 10 to the main signal processing unit 12 through the camera signal processing unit 11 for recording in the medium, or image information (video signal data) recorded in the medium and read by the media drive 14 to the main signal processing unit 12 for playback. The video source having the HD signal format is also hereinafter referred to as an “HD source,” and the video source having the SD signal format is also hereinafter referred to as an “SD source.”

In the present embodiment, the display-output-system transmission channel 20 between the main signal processing unit 12 and the display-output-system signal processing unit 15 transmits the transmission baseband data according to CCIR Rec. 656. This data transmission to the display output system is also performed according to the transmission signal formats adapted for HD and SD sources.

However, due to the difference in signal format between the HD and SD sources, the HD and SD sources also have different basic transmission formats such as a transmission data structure in a frame period and a transmission rate. For example, if transmission is simply performed without taking account of such differences in transmission format between the HD and SD sources, the following problems may occur.

For example, it is assumed that the video source being processed by the main signal processing unit 12 is switched between HD and SD sources.

As described above with reference to FIG. 1, the video signal data processed by the main signal processing unit 12 for recording or playback is also transmitted to the display-output-system signal processing unit 15 from the main signal processing unit 12 via the display-output-system transmission channel 20 for monitor display or playback. Therefore, the transmission baseband data input to the display-output-system signal processing unit 15 is also switched between the HD and SD sources. As described above, the HD and SD sources have different transmission formats. Therefore, when signal source switching occurs between the HD and SD sources, the timing of the corresponding frame period, that is, the timing of the vertical synchronizing signal cycle as a video signal (vertical synchronization timing), is deviated. Such deviation in vertical synchronization timing causes a distortion in a displayed image such as an image processed by the display-output-system signal processing unit 15 and displayed on the display unit 16 or the viewfinder 17, or an image displayed using an external display device or the like on the basis of a video signal output from the external signal output terminals (the D-terminal 18 and the LINE OUT terminal 19).

Such a signal format switching may occur, for example, when during playback of video signal data as a video source stored in a medium placed in the media drive 14, the signal format of the video source is switched between the HD and SD formats. The image played back through the display-output-system signal processing unit 15 may also be distorted depending on the structure of the recording signal processing system when the recording signal format is switched between the HD and SD formats during the capturing and recording operation.

The video camera apparatus 1 of the present embodiment has a structure in which such a distortion in a displayed image can be prevented even if the video source is switched between the HD and SD sources. This structure will now be described.

First, a baseband data format used by the video camera apparatus 1 of the present embodiment for video signal transmission to at least the display output system will be described.

The term baseband data for the display output system, as used herein, includes two types of baseband data: transmission baseband data and basic baseband data. As described above, the transmission baseband data is baseband data (video signal data) transmitted from the main signal processing unit 12 to the display-output-system signal processing unit 15 via the display-output-system transmission channel 20. The basic baseband data is initial baseband data (video signal data) that the transmission baseband data is based on and that is obtained according to either HD or SD signal format.

First, the formats (signal formats) of the basic baseband data will be described. In particular, the HD and SD formats under the NTSC system (hereinafter referred to as “NTSC-HD” and “NTSC-SD,” respectively), and the HD and SD formats under the PAL system (hereinafter referred to as “PAL-HD” and “PAL-SD,” respectively) will be described.

In this case, video signal data as the basic baseband data is associated with a color image, which is common to the NTSC-HD, NTSC-SD, PAL-HD, and PAL-SD formats, and is in a component signal format with a sampling ratio of 4:2:2 for brightness signal data Y and color-difference signal data Cr (Y-R) and Cb (Y-B).

Further, the number of line clocks and the number of horizontal lines corresponding to one frame image are specified as below for each of the television formats:

for NTSC-HD,
Number of line clocks: 1650
Number of horizontal lines: 1125

for NTSC-SD,
Number of line clocks: 858
Number of horizontal lines: 525

for PAL-HD,
Number of line clocks: 1980
Number of horizontal lines: 1125

for PAL-SD,
Number of line clocks: 864
Number of horizontal lines: 625

The number of line clocks is defined as the number of clocks determined according to the number of horizontal pixels per horizontal line. The number of clocks is defined as the number of consecutive cycles of clocks (transmission clocks) for data transmission at a predetermined frequency.

The frequency of the data rate fdr for each of the television formats in which the number of line clocks and the number of lines are specified as above is determined by the equation below if the television format is an interlaced format in which one frame contains an even-numbered field and an odd-numbered field:
fdr=number of line clocks×number of lines per field×field frequency Eq. (1)

The data rates fdr of the NTSC-HD, NTSC-SD, PAL-HD, and PAL-SD television formats determined by Eq. (1) above are as follows:

For NTSC-HD,
1650×(1125/2)×59.94≈55.63186813 MHz

(where 59.94=4.5 M/75075)

For NTSC-SD,
858×(525/2)×59.94=13.5 MHz

(where 59.94=4.5M/75075)

For PAL-HD,
1980×(1125/2)×50=55.6875 MHz

For PAL-SD,
864×(625/2)×50=13.5 MHz

As can be seen from above, in both NTSC and PAL systems, the data rate of the HD format is about four times that of the SD format.

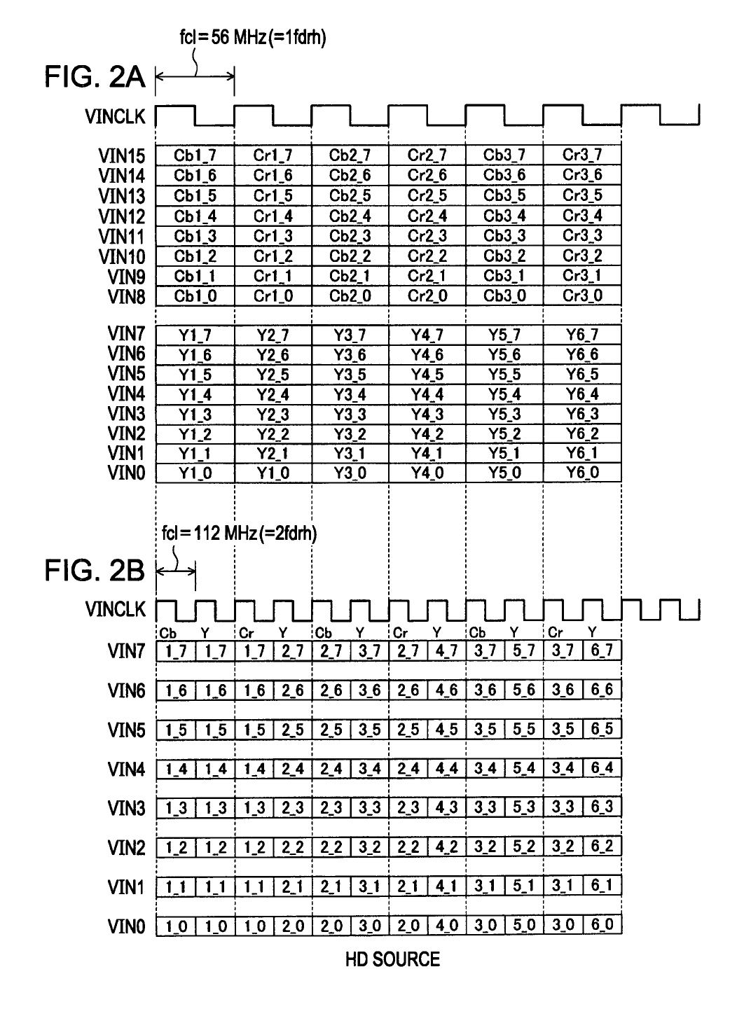

Next, the data structure of the basic baseband data transmitted at the data rate determined as above will be described. FIG. 2A shows a data array of component signals (Y, Cb, and Cr) when HD-source basic baseband data is transmitted.

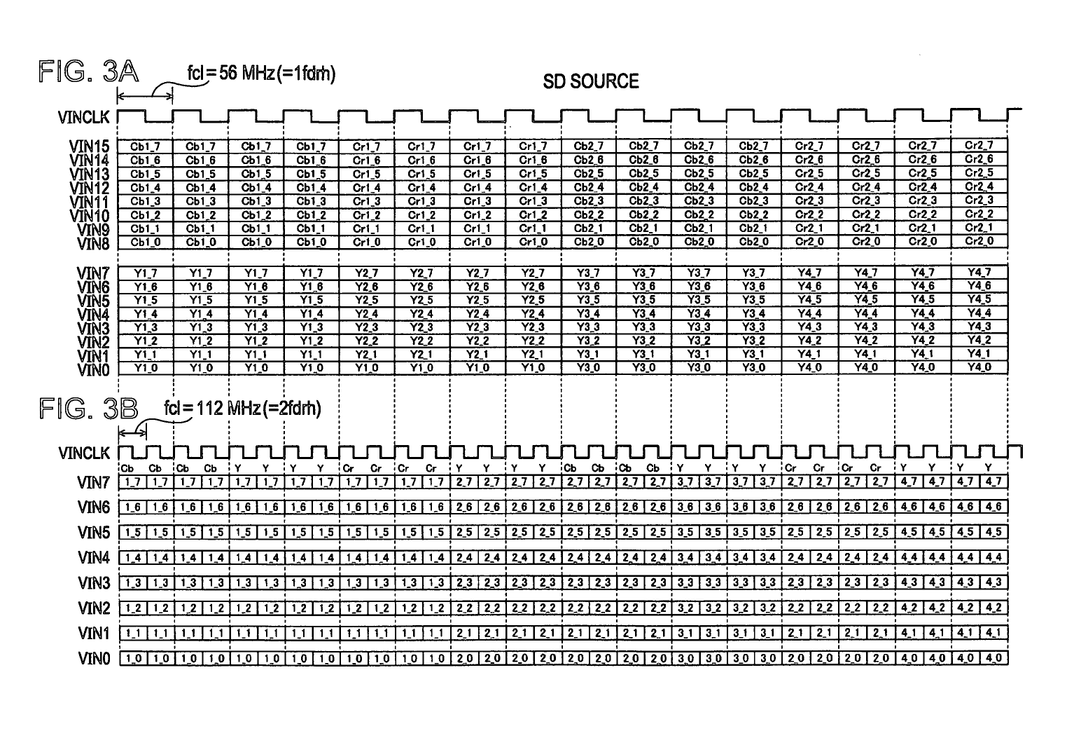

In the following description of the data array, for ease of description, the frequencies of the data rates for the NTSC-HD and PAL-HD formats among the data rates determined as above are used as 56 MHz, which is an approximation of 55.63186813 MHz and 55.6875 MHz, respectively. Therefore, as can be understood from the following description, the transmission format of baseband data for data transmission at every clock cycle shown in FIGS. 2B and 3B can be commonly used for the NTSC and PAL systems. The HD source under the NTSC and PAL systems has a data rate frequency fdrh of the approximation 56 MHz. The SD source under the NTSC and PAL systems has a data rate frequency fdrs of 13.5 MHz.

If the data rate frequency fdr is set to 56 MHz in the manner described above, a frequency (hereinafter also referred to as a “transmission clock frequency”) fcl of transmission clocks VINCLK for data transmission can also be set to 56 MHz. FIG. 2A shows the transmission clocks VINCLK having a frequency fcl of 56 MHz (=1 fdrh).

It is also specified that, as described above, the Y-Cb-Cr component signal format has a ratio of 4:2:2 and that each of Y, Cb, and Cr signal data is transmitted in units of eight bits at every clock.

Accordingly, in the transmission format shown in FIG. 2A, first, 16-bit parallel transmission lines VIN0 to VIN15 are provided. The parallel transmission lines VIN0 to VIN7 transmit 8-bit brightness signal data Yn_0 to Yn_7 (in FIG. 2A, [Y1_0 to Y1_7] to [Y6_0 to Y6_7] are illustrated) at every clock, and the remaining parallel transmission lines VIN8 to VIN15 alternately transmit 8-bit color difference signal data Cbn_0 to Cbn_7 (in FIG. 2A, [Cb1_0 to Cb1_7] to [Cb3_0 to Cb3_7] are illustrated) and 8-bit color difference signal data Crn_0 to Crn_7 (in FIG. 2A, [Cr1_0 to Cr1_7] to [Cr3_0 to Cr3_7] are illustrated) at every clock.

With this transmission format, the HD-source video signal data in NTSC-HD or PAL-HD can be appropriately transmitted as basic baseband data.

A 16-bit transmission channel corresponding to the parallel transmission lines VIN0 to VIN15 is used for the data array shown in FIG. 2A. In the actual hardware implementation, the number of bits of the transmission channel coincides with the number of pin terminals (or the number of ports) used for a transmission channel (bus) in LSI design or the like. Thus, the larger the number of bits of the transmission channel, the larger the number of pin terminals or the number of ports. As the number of pins used in a certain application increases, the number of pin terminals provided for LSI devices also increases, resulting in disadvantages such as an increase in size or a problem in that a finite number of pin terminals allow a little room for various types of use. It is often preferable to minimize the number of used pin terminals.

The basic data array of the HD source shown in FIG. 2A is changed to, for example, that shown in FIG. 2B, whereby the number of bits of the transmission channel can be reduced.

That is, as shown in FIG. 2B, the frequency fcl of the transmission clocks VINCLK is set to 112 MHz, which is twice the data rate frequency fdrh of 56 MHz. In the manner shown in FIG. 2B, for example, first, at the first clock, the 8-bit color difference signal data Cb1_0 to Cb1_7, which are transmitted by the parallel transmission lines VIN8 to VIN15 at the first clock shown in FIG. 2A, are transmitted by the parallel transmission lines VIN0 to VIN7. At the second clock, the 8-bit brightness signal data Y1_0 to Y1_7, which are transmitted by the parallel transmission lines VIN0 to VIN7 at the first clock shown in FIG. 2A, are transmitted. At the third clock, the 8-bit color difference signal data Cr1_0 to Cr1_7, which are transmitted by the parallel transmission lines VIN8 to VIN15 at the second clock shown in FIG. 2A, are transmitted. At the fourth clock, the 8-bit brightness signal data Y2_0 to Y2_7, which are transmitted by the parallel transmission lines VIN0 to VIN7 at the second clock shown in FIG. 2A, are transmitted. The subsequent brightness signal data Y and color difference signal data Cb and Cr are transferred in a similar sequence. That is, in FIG. 2B, the procedure of sequentially transferring each of the 8-bit color difference signal data Cbn_0 to Cbn_7, brightness signal data Yn_0 to Yn_7, and color difference signal data Crn_0 to Crn_7 at every clock (or every clock cycle) of the transmission clocks VINCLK using the parallel transmission lines VIN0 to VIN7 is repeated.

With the format of the above-described data array, while the amount of data transmitted per unit time is the same as that shown in FIG. 2A, the number of parallel transmission lines can be reduced to eight, i.e., the 8-bit parallel transmission lines VIN0 to VIN7.

In the present embodiment, the baseband data having the data array shown in FIG. 2B is transmitted between the main signal processing unit 12 and the display-output-system signal processing unit 15. That is, while the data array of the basic baseband data of the HD source is shown in FIG. 2A, the data transmitted with the data array shown in FIG. 2B is the entity of the component signals in the transmission baseband data as the HD source in the present embodiment.

With this signal format, the number of bits of the display-output-system transmission channel 20 can be reduced to eight while the display-output-system transmission channel 20 normally has a capacity of 16 bits. Further, for example, the number of pin terminals (or ports) used for baseband data transmission in the LSI components serving as the main signal processing unit 12 and the display-output-system signal processing unit 15 can be reduced accordingly.

As described above, in the video camera apparatus 1 of the present embodiment, the 8-bit display-output-system transmission channel 20 serving as a parallel transmission channel transmits is used for baseband data transmission between the main signal processing unit 12 and the display-output-system signal processing unit 15. Further, the transmission clock frequency fcl is set to 112 MHz for HD-source transmission, which is twice the data rate frequency fdrh of the basic baseband data.

However, the above-described structure for baseband data transmission may experience a problem of matching with the SD source.

That is, in the present embodiment, both HD and SD sources are transmitted from the main signal processing unit 12 to the display-output-system signal processing unit 15. In this case, it is difficult to transmit the SD-source basic baseband data at a transmission clock frequency fcl of 112 MHz (=2 fdrh) in accordance with the baseband data transmission structure shown in FIG. 2A. The SD-sources (NTSC-SD or PAL-HD) basic baseband data has a data rate frequency fdrs of 13.5 MHz, and transmission is normally performed at the same transmission clock frequency as that data rate frequency.

If the HD source is transmitted by transmission clocks having a frequency fcl of 112 MHz and the SD source is transmitted by transmission clocks having a frequency fcl of 13.5 MHz, the transmission clock frequencies are switched depending on the HD and SD sources.

In this case, since the frequencies of the transmission clocks are switched, continuity of frame periods is not ensured before and after the switching. This results in a distortion in a displayed image due to the deviation in vertical synchronization timing, which is to be overcome by the present embodiment.

In the present embodiment, therefore, the frequency fcl of the transmission clocks for SD-source transmission is also set to 112 MHz, which is equal to that set for the HD source. That is, in the present embodiment, transmission is performed at the same fixed clock frequency regardless of the HD or SD signal format. Although the desired SD-source transmission format is shown in FIG. 3B, a description thereof will be given step-by-step for ease of description.

The data array of component signals when SD-source basic baseband data is transmitted at the same transmission clock frequency as the original data rate frequency fdrs, i.e., 13.5 MHz, is obtained on the basis of that shown in FIG. 2A, where the frequency fcl of the transmission clocks VINCLK is set to 13.5 MHz. As described above, the SD source also has a Y-Cb-Cr video signal data format with a rate of 4:2:2. Therefore, as in the HD source, the format based on that shown in FIG. 2A is the most basic format for SD-source baseband data transmission.

Then, the SD source basic baseband data is transmitted at a frequency of the transmission clocks VINCLK equal to the data rate frequency fdrh of the HD-source basic baseband data of the, i.e., 56 MHz.

As described above, the data rate frequency for the HD basic baseband data is substantially four times that for the SD basic baseband data. Therefore, as shown in FIG. 3A, the 16-bit data to be typically transmitted at the timing of one clock is transmitted consecutively (by multiplexing) four times. Therefore, the contents of the transmitted data are updated once substantially every four clocks, which is equivalent to the timing of one clock cycle with 13.5 MHz (=56 MHz/4), which is equal to the transmission rate frequency for the basic baseband data. No deviation occurs in timing of the SD-source data transmission.

As described above with reference to FIG. 2B, when the SD source is transmitted via the display-output-system transmission channel 20 having a transmission clock frequency fcl of 112 MHz and including the 8-bit parallel transmission lines VIN0 to VIN7, the data array of component signals is changed from that shown in FIG. 3A to that shown in FIG. 3B.

That is, for example, at the first to fourth clocks shown in FIG. 3B, the 8-bit color difference signal data Cb1_0 to Cb1_7, which are transmitted by the parallel transmission lines VIN8 to VIN15 at the first to fourth clock cycles shown in FIG. 3A, are transmitted consecutively (by multiplexing) four times. At the fifth to eighth clocks, the 8-bit brightness signal data Y1_0 to Y1_7, which are transmitted by the parallel transmission lines VIN0 to VIN7 at the first to fourth clock cycles shown in FIG. 3A, are transmitted consecutively four times. At the ninth to 12th clocks, the 8-bit color difference signal data Cr1_0 to Cr1_7, which are transmitted by the parallel transmission lines VIN8 to VIN15 at the fifth to eight clock cycles shown in FIG. 3A, are transmitted consecutively (by multiplexing) four times. At the 13th to 16th clocks, the 8-bit brightness signal data Y2_0 to Y2_7, which are transmitted by the parallel transmission lines VIN0 to VIN7 at the fifth to eighth clock cycles shown in FIG. 3A, are transmitted consecutively four times. The subsequent data transmission is repeatedly continuously performed according to the above-described sequences.

In comparison between the transmission formats shown in FIGS. 3A and 3B, the contents of the data transmitted in eight clock cycles according to the transmission format shown in FIG. 3A are the same as the contents of the data transmitted in four clock cycles according to the transmission format shown in FIG. 3B. That is, although the frequency fcl of the transmission clocks VINCLK is set to 112 MHz, data transmission is substantially performed at a frequency equal to the data rate frequency for the SD source (fdrs=13.5 MHz).

As in the above-described signal data array of the SD source shown in FIG. 3B, multiplexed transmission in accordance with the data rate relative to the HD source allows transmission of the SD source using, for example, transmission clocks commonly set on the basis of the HD source. When viewed as one entire frame, however, the number of clocks (the number of data) per horizontal line for the NTSC-SD source is adjusted as below.

First, the number of data (the number of clocks clk) for one frame of the NTSC-HD source is determined by Eq. (2) below on the basis of the number of line clocks (i.e., 1650) and the number of horizontal lines (i.e., 1125) in the basic baseband data format. The transmission clock frequency fcl is set to 112 MHz (=2 fdrh) in accordance with the transmission format of the present embodiment.
1650×1125×(112/56)=3712500clk Eq. (2)

In the present embodiment, as described above with reference to FIGS. 2A to 3B, baseband data is transmitted by the transmission clocks VINCLK with the frequency fcl commonly set to 112 MHz for the HD and SD sources. Therefore, while the SD-source transmission data has been multiplexed, the data for one frame period is transmitted using 3712500 clocks, as determined by Eq. (2) above.

In the NTSC-SD source, the total number of horizontal lines of one frame is 525. If the number of clocks corresponding to one horizontal line is simply determined, a non-natural number solution is obtained as follows:
3712500clk/525≈7071.4 Eq. (3)

Since the number of clocks corresponding to one horizontal line should be a natural number, it is difficult to correctly determine the number of clocks per horizontal line for the NTSC-SD source.

It is to be understood that, as can been seen from the number of clocks of one frame for the NTSC-HD source determined by Eq. (2), the number of clocks corresponding to one horizontal line at a transmission clock frequency fcl of 112 MHz is 3300 (=1650×2), which is twice the number of horizontal clocks of the basic baseband data. Therefore, a natural number solution can be obtained.

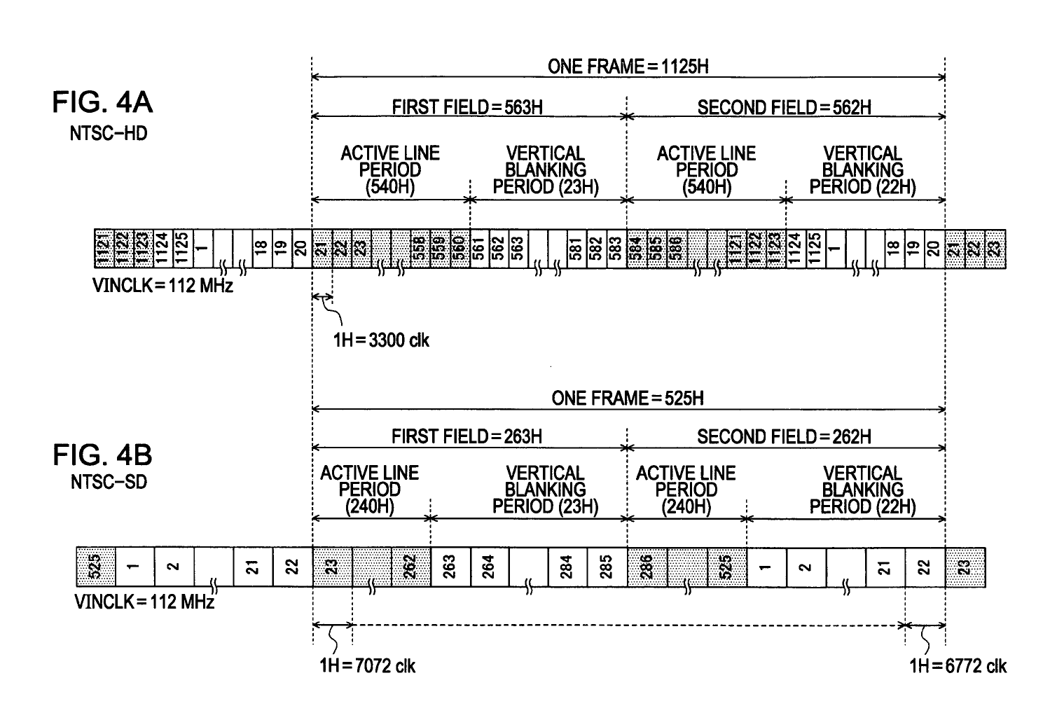

If the video camera apparatus 1 of the present embodiment is NTSC-compatible, the number of clocks per horizontal line is determined in the manner shown in FIG. 4B.

FIG. 4B shows a horizontal line structure for one frame period of the NTSC-SD source in correspondence with the number of clocks of the transmission clocks VINCLK (fcl=112 MHz). FIG. 4A shows a horizontal line structure for one frame of the NTSC-HD source, for the purpose of comparison with that shown in FIG. 4B.

First, in the horizontal line structure for the NTSC-HD source shown in FIG. 4A, one frame is formed of 1125 horizontal lines (1125H). In this case, a frame starts with the 21st horizontal line in one interval, and ends with the 20th horizontal line in the next interval. Of the 1125 horizontal lines, the first half 563 horizontal lines correspond to a first field (odd-numbered field), and the second half 562 horizontal lines correspond to a second field (even-numbered field).

In the first field, a period of 540 horizontal lines from the 21st line, which is the top of the field, to the 560th line serves as an active line period including active horizontal lines as an image, and a period of 23 subsequent horizontal lines from the 561st line to the 583rd line, which is the end of the field, serves as a vertical blanking period corresponding to a vertical blanking period for each field. In the second field, a period of 540 horizontal lines from the 584th line, which is the top of field, to the 1123rd line serves as an active line period, and a period of 22 subsequent horizontal lines from the 1124th line to the 20th line, which is the end of the field, serves as a vertical blanking period. As shown in FIG. 4A, each line (1H) of the active line period and the vertical blanking period has 3300 clocks, as determined above according to Eq. (2).

The horizontal line structure for the NTSC-SD source shown in FIG. 4B will now be described.

A frame of the NTSC-SD source is formed of 525 horizontal lines (525H) from the 23rd line in one interval to the 22nd line in the next interval, in which the first half 263 horizontal lines correspond to a first field and the second half 262 horizontal lines correspond to a second field. In the first field, a period of 240 horizontal lines from the 23rd line, which is the top of the field, to the 262nd line serves as an active line period, and a period of 23 subsequent horizontal lines from the 263rd line to the 285th line serves as a vertical blanking period. In the second field, a period of 240 horizontal lines from the 286th line, which is the top of the field, to the 525th line serves as an active line period, and a period of 22 subsequent horizontal lines from the first line to the 22nd line serves as a vertical blanking period.

The correspondence between the horizontal lines and the number of clocks for the NTSC-SD source is determined as follows.

That is, in one frame period shown in FIG. 4B, each of the 524 horizontal lines from the 23rd line, which is the top of the frame, to the 21st line one line preceding the end line of the frame has 7072 clocks. The number of clocks for the 524 horizontal lines is given by 7072×524=3705728, and the number of clocks for the remaining horizontal line in one frame is given by 3712500−3705728=6772. Therefore, the last horizontal line in one frame period, namely, the 22nd line, has 6772 clocks.

By determining the number of clocks per horizontal line in the manner described above, the number of clocks can be set to the same value, namely, 7072 clk, for all the horizontal lines of the active line periods. The 22nd line for which the number of clocks is different from that for the other horizontal lines is a horizontal line of the vertical blanking period, and is not active for an image. There is substantially no adverse effect on display or the like.

In the PAL system, on the other hand, unlike the NTSC system, it is not necessary to adjust the number of clocks per horizontal line for the SD source.

That is, the number of clocks corresponding to one frame of the PAL-HD source is represented by the equation below on the basis of the number of line clocks (i.e., 1980) and the number of horizontal lines (i.e., 1125) in the basic baseband data format:
1980×1125×(112/56)=4455000clk Eq. (4)

The number of horizontal lines forming one frame of the PAL-SD source is 625. Therefore, the number of clocks per horizontal line is given as follows:
4455000clk/625=7128clk Eq. (5)

Therefore, all 625 horizontal lines have the same number of clocks, namely, 7128.

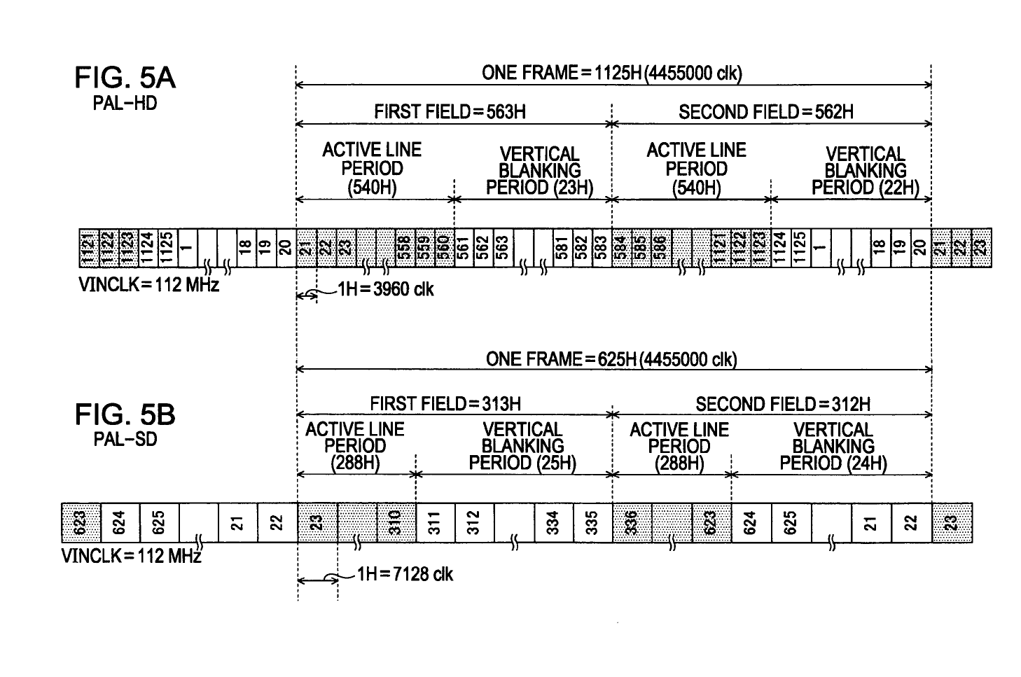

FIGS. 5A and 5B show horizontal line structures for one frame period of the PAL-HD and PAL-SD sources, respectively, in correspondence with the number of clocks of the transmission clocks VINCLK (fcl=112 MHz).

First, the horizontal line structure for the PAL-HD source is similar to that for the NTSC-HD source shown in FIG. 4A. However, as defined above by Eq. (4), the number of clocks for one frame is 4455000. Since the number of horizontal clocks of the basic baseband data is 1980, the number of clocks per horizontal line for the PAL-HD source is 3960 (=1980×2).

Then, in the horizontal line structure for the PAL-SD source, one frame is formed of 625 horizontal lines from the 23rd line in one interval to the 22nd line in the next interval, in which the first half 313 horizontal lines correspond to a first field and the second half 312 horizontal lines correspond to a second field. In the first field, a period of 288 horizontal lines from the 23rd line, which is the top of the field, to the 310th line serves as an active line period, and a period of 25 subsequent horizontal lines from the 311th line to the 335th line serves as a vertical blanking period. In the second field, a period of 288 horizontal lines from the 336th line, which is the top of the field, to the 623rd line serves as an active line period, and a period of 24 subsequent horizontal lines from the 624th line to the 22nd line serves as a vertical blanking period. Each of the horizontal lines uniformly has 7128 clocks per horizontal line, as defined above by Eq. (5).

As described above, the data array of component signals in accordance with the clock cycles for the NTSC-HD source transmission baseband data transmitted by the display-output-system transmission channel 20 is shown in FIGS. 2B and 4A, that for the NTSC-SD source is shown in FIGS. 3B and 4B, that for the PAL-HD source is shown in FIGS. 2B and 5A, and that for the PAL-SD source is shown in FIGS. 3B and 5B. In the actual transmission of transmission baseband data by the display-output-system transmission channel 20, as described above, the data having the arrays described above is transmitted in a CCIR Rec. 656 compatible format.

Next, a CCIR Rec. 656 compatible data format for the transmission baseband data will be described.

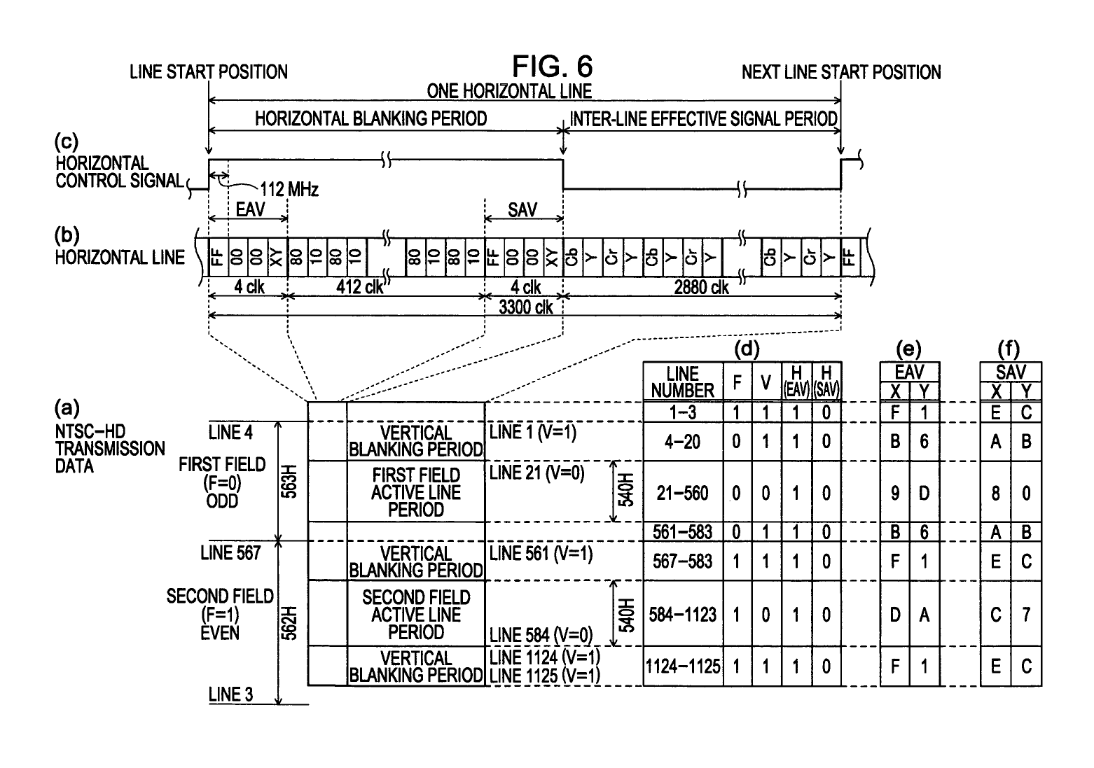

FIG. 6 shows the data format of the NTSC-HD source transmission baseband data.

In part (a) of FIG. 6, the structure of transmission data for one frame (frame data structure) of the NTSC-HD source is illustrated. In the NTSC-HD source, as described above, one frame is formed of 1125 horizontal lines. In this case, a period from the first line (LINE 1) to the 20th line is a vertical blanking period, a period from the 21st line (LINE 21) to the 560th line is an active line period of the first field, a period from the 561st line (LINE 561) to the 583rd line is a vertical blanking period, a period from the 584th line (LINE 584) to the 1123rd line is an active line period of the second field, and a period from the 1124th line (LINE 1124) to the 1125th line (LINE 1125) is a vertical blanking period. In part (a) of FIG. 6, the first field is formed of the fourth to 566th lines, and the second field is formed of the 567th to third lines. Although the range of each of the fields shown in part (a) of FIG. 6 is different from that shown in FIG. 4A, this is merely a variation in design of the field start position. The structure shown in part (a) of FIG. 6 and the structure shown in FIG. 4A are common in that the first field has a period of 563 horizontal lines including an active line period from the 21st to 560th lines and the second field has a period of 562 horizontal lines including an active line period from the 584th to 1123rd lines.

In part (b) of FIG. 6, the structure of data for one horizontal line (line data structure) in the frame data structure shown in part (a) of FIG. 6 is illustrated. The line data structure shown in part (b) of FIG. 6 is associated with a horizontal control signal shown in part (c) of FIG. 6. The horizontal control signal is a signal indicating a timing in a horizontal line period. For example, the horizontal control signal is used as one timing signal when the transmission baseband data shown in FIG. 6 is generated.

As described above with reference to FIG. 4A, one horizontal line of the NTSC-HD source has 3300 clocks, wherein the clock frequency fcl of the transmission clocks VINCLK is 112 MHz. Of the 3300 clocks, a period of 420 clocks from the top is set as a horizontal blanking period, and a period of the remaining 2880 clocks is set as an inter-line effective signal period. In the inter-line effective signal period, effective component signal data (Cb, Y, and Cr) for an image can be arranged in a horizontal line in the manner shown in FIG. 2B. However, the effective component signal data are truly arranged in the inter-line effective signal period only within the active line period of the first or second field shown in part (a) of FIG. 6. The effective image signal data are not arranged in the inter-line effective signal period within the vertical blanking periods.

In the horizontal blanking period within one horizontal line, in compliance with CCIR Rec. 656, a period of four clocks from the top (the frame start position) is set as the end of active video (EAV) and a period of the last four clocks in the horizontal blanking period is set as the start of active video (SAV).

EAV is a code region indicating the end of the immediately preceding inter-line effective signal period, and SAV is a code region indicating the beginning of the immediately following inter-line effective signal period.

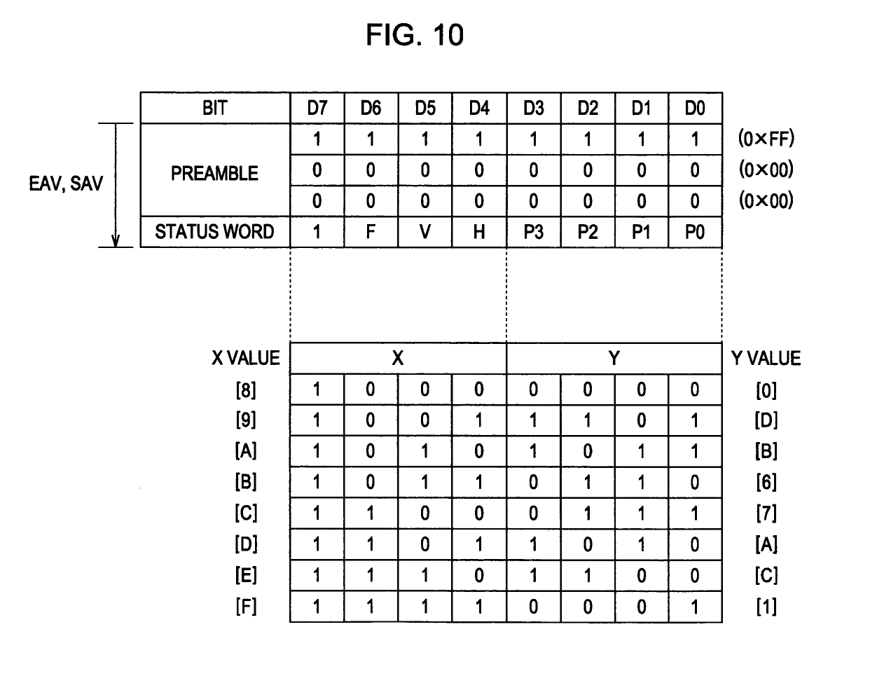

FIG. 10 shows an example structure of the EAV and SAV codes.

Each of the EAV and SAV codes has four clocks each clock corresponding to 8-bit (1-byte) data (hereinafter referred to as “clock unit data”) D7 to D0. The 8-bit data D7 to D0 of the clock unit data are transmitted by, for example, the parallel transmission lines VIN7 to VIN0 shown in FIG. 2B, respectively.

In the clock unit data for the four clocks assigned to each of the EAV and SAV codes, a region of the clock unit data for the first to third clocks is set as a preamble, and unique patterns are assigned. As shown in FIG. 10, pattern “11111111” (0xFF) is assigned to the clock unit data D7 to D0 for the first clock, and pattern “00000000” (0x00) is assigned to the clock unit data D7 to D0 for the second and third clocks.

The clock unit data for the fourth clock assigned to each of the EAV and SAV codes is set as a status word having substantial meaning. In an example definition of the meaning, the data D7 is constantly set to 1, the data D6 is defined as a field identifier [F], the data D5 is defined as a vertical blanking identifier [V], and the data D4 is defined as an EAV/SAV identifier [H].

The remaining data bits D3, D2, D1, and D0 are defined as parities P3, P2, P1, and P0, respectively, and serve as, for example, error detection codes for the data bits D7 to D4 in the status word. The parity P3 is set to a value determined by performing an exclusive OR between the vertical blanking period identifier [V] and the EAV/SAV identifier [H]. The parity P2 is set to a value determined by performing an exclusive OR between the field identifier [F] and the EAV/SAV identifier [H], and the parity P1 is set to a value determined by performing an exclusive OR between the field identifier [F] and the vertical blanking period identifier [V]. The parity P0 is set to a value determined by performing an exclusive OR between the field identifier [F], the vertical blanking period identifier [V], and the EAV/SAV identifier [H].

As shown FIG. 10, the status word can have eight bit patterns for the data bits D7 to D0 as follows:

10000000 (pattern 1)

10011101 (pattern 2)

10101011 (pattern 3)

10110110 (pattern 4)

11000111 (pattern 5)

11011010 (pattern 6)

11101100 (pattern 7)

11110001 (pattern 8)

If the four bits D7 to D4 are replaced by X and the four bits D3 to D0 are replaced by Y in the above-described bit patterns of the status word, patterns 1 to 8 of the bit patterns in the form of X and Y are represented by hexadecimal notation as follows:

0x80 (pattern 1)

0x9D (pattern 2)

0xAB (pattern 3)

0xB6 (pattern 4)

0xC7 (pattern 5)

0xDA (pattern 6)

0xEC (pattern 7)

0xF1 (pattern 8)

The meaning of the status word is shown in part (d) of FIG. 6.

The field identifier [F] indicates that the corresponding horizontal line belongs to the first field (odd field) when it is set to 0, and belongs to the second field (even field) when it is set to 1. Accordingly, in both EAV and SAV codes, the field identifier [F] is set to 1 for the first to third and 567th to 1125th lines, and is set to 0 for the fourth to 566th lines.

In both EAV and SAV codes, the vertical blanking period identifier [V] is set to 1 for the first to 20th, 561st to 583rd, 1124th, and 1125th lines, indicating a vertical blanking period, and is set to 0 for the 21st to 560th and 584th to 1123rd lines, indicating an active line period.

The EAV/SAV identifier [H] is set to 1 for all the horizontal lines in the EAV code, indicating EAV, and is set to 0 for all the horizontal lines in the SAV code, indicating SAV.

The status words in the EAV and SAV codes within one frame have the bit patterns shown in parts (e) and (f) of FIG. 6, respectively. As can be seen from the comparison between the bit patterns shown in parts (e) and (f) of FIG. 6 and the frame structure shown in part (a) of FIG. 6, the eight bit patterns (XY) set as the status word in the EAV and SAV codes shown in FIG. 10 serve as codes for identifying the EAV or SAV code and identifying to which period within the frame the corresponding horizontal line belongs, as follows:

0x80 (pattern 1): SAV code belonging to the active line period of the first field

0x9D (pattern 2): EAV code belonging to the active line period of the first field

0xAB (pattern 3): SAV code belonging to the vertical blanking period of the first field

0xB6 (pattern 4): EAV code belonging to the vertical blanking period of the first field

0xC7 (pattern 5): SAV code belonging to the active line period of the second field

0xDA (pattern 6): EAV code belonging to the active line period of the second field

0xEC (pattern 7): SAV code belonging to the vertical blanking period of the second field

0xF1 (pattern 8): EAV code belonging to the vertical blanking period of the second field

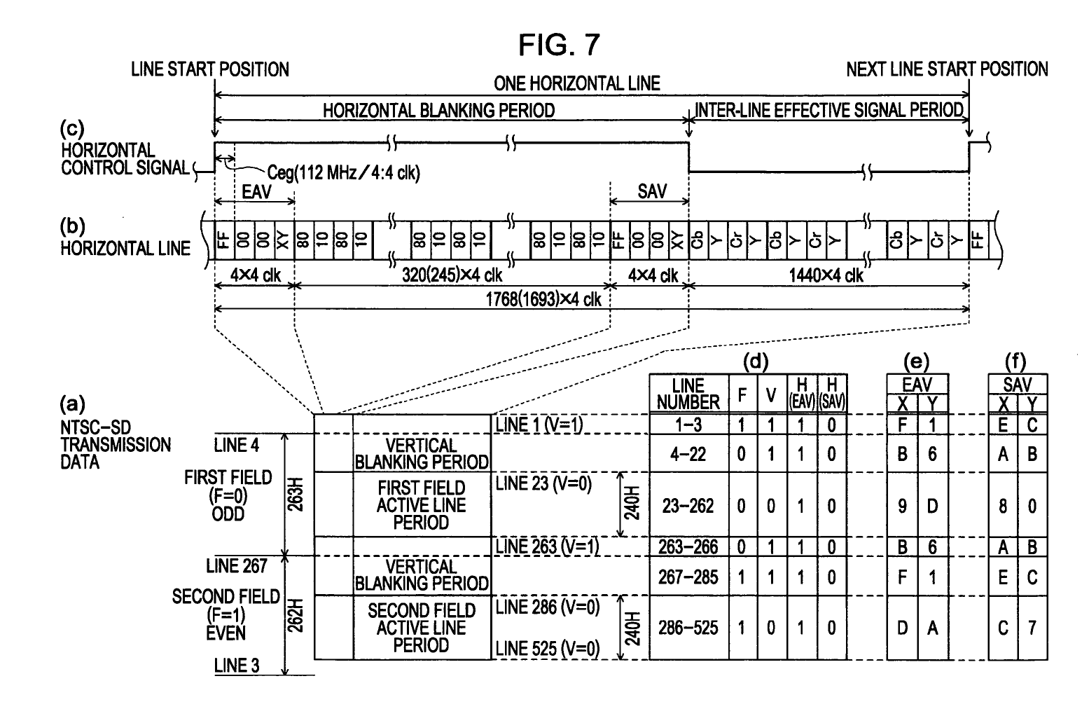

FIG. 7 shows the data format of the NTSC-SD transmission baseband data. The meaning of the data format shown in FIG. 7, equivalent to that shown in FIG. 6, is not described herein.

In the frame data structure for the NTSC-SD source shown in part (a) of FIG. 7, one frame is formed of 525 horizontal lines, in which a period from the first line (LINE 1) to the 22nd line is set as a vertical blanking period, a period from the 23rd line (LINE 23) to the 262nd line is set as an active line period of a first field, a period from the 263rd line (LINE 263) to the 285th line is set as a vertical blanking period, and a period from the 286th line (LINE 286) to the 525th line is set as an active line of a second field. In part (a) of FIG. 7, the first field is formed of the fourth to 266th lines, and the second field is formed of the 267th to third lines. Although the range of each of the fields shown in part (a) of FIG. 7 is different from that shown in FIG. 4B, the structure shown in part (a) of FIG. 7 and the structure shown in FIG. 4B are common in that, as in the NTSC-HD source, the first field has a period of 263 horizontal lines including an active line period from the 23rd to 262nd lines and the second field has a period of 262 horizontal lines including an active line period from the 286th to 525th lines.

In part (b) of FIG. 7, a data segment Ceg indicates a period represented as clock unit data for one clock shown in part (b) of FIG. 6. The data segment Ceg has a period of four clocks on the premise that the clock frequency fcl of the transmission clocks VINCLK is 112 MHz, and is represented by a frequency of 112 MHz/4. As shown in FIG. 3B, the SD source is transmitted so that the same data of 8 bits is transmitted four times at every clock for a period of four clocks. The data segment Ceg indicates a period of four clocks in which the same data is multiplexed four times and transmitted.

As described with reference to FIG. 4B, each of the horizontal lines of the NTSC-SD source from the 23rd line in one interval to the 21st line in the next interval has 7072 (=1768×4) clocks, and only the 22nd line has 6772 (=1693×4) clocks.

For example, within one horizontal line period shown in part (b) of FIG. 7, in a horizontal blanking period for which a horizontal control signal shown in part (c) of FIG. 7 is set to a high level, each of the horizontal lines from the 23rd line in one interval to the 21st line in the next interval has 1280 (=320×4) clocks, and the 22nd line has 980 (=245×4) clocks. Each of all the horizontal lines in an inter-line effective signal period subsequent to the horizontal blanking period has 5760 (=1440×4) clocks. That is, when viewed in units of horizontal lines, the number of clocks for the 22nd line is adjusted by setting the number of clocks corresponding to the horizontal blanking period. Therefore, the number of clocks corresponding to the inter-line effective signal period is set to the same value for all the horizontal lines to prevent the complexity of signal processing.

Also in the NTSC-SD transmission baseband data, a period of the first four clocks in the horizontal blanking period is set as the EAV code, and a period of the last four clocks is set as the SAV code. As can also be seen from parts (a), (d), (e), and (f) of FIG. 7, any of the above-described eight bit patterns (pattern 1 to pattern 8) is set as the status word of each of the EAV and SAV codes depending on the EAV or SAV code and to which period the corresponding horizontal line belongs.

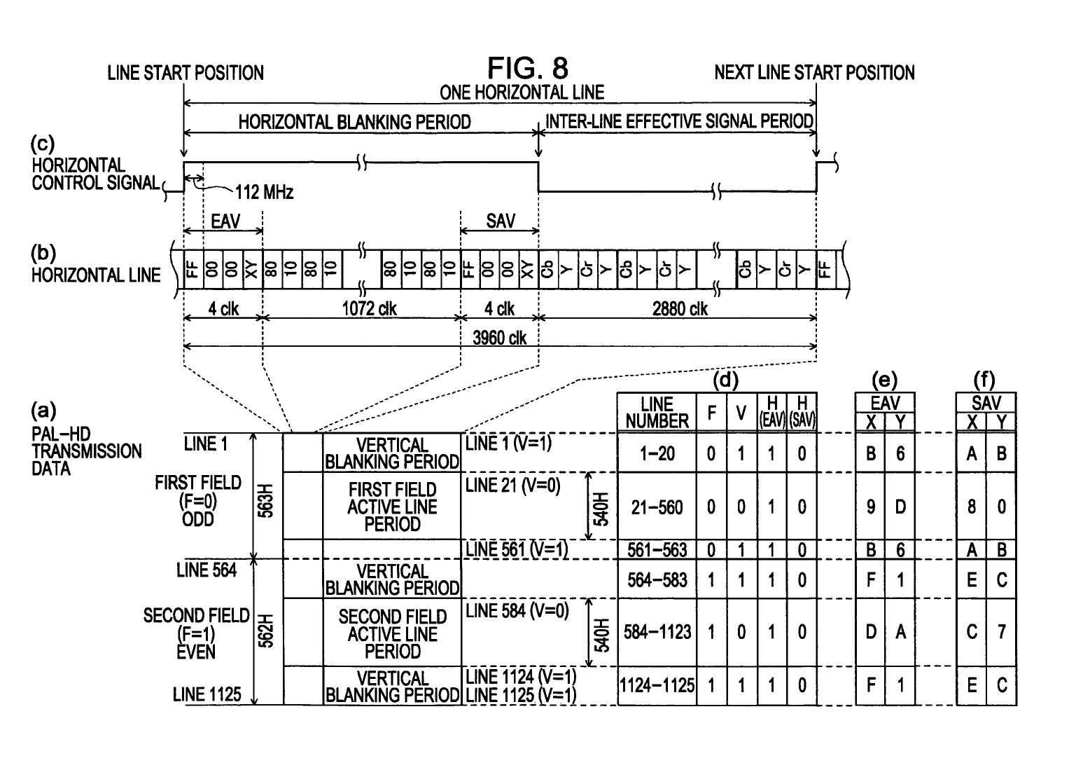

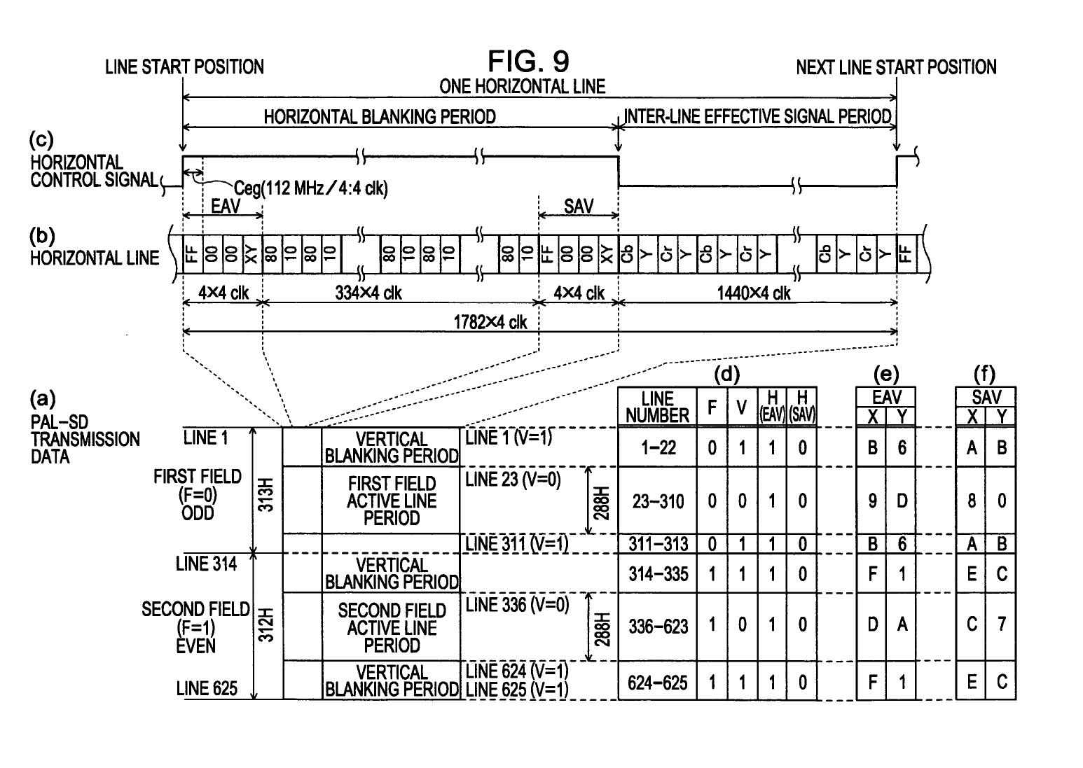

FIGS. 8 and 9 show the data formats of the PAL-HD and PAL-SD transmission baseband data, respectively. The meaning of the data formats shown in FIGS. 8 and 9, equivalent to that shown in FIGS. 6 and 7, is not described herein.

First, the data format of the PAL-HD transmission data shown in FIG. 8 will be described.

In the PAL-HD frame structure, the number of horizontal lines forming one frame is 1125, which is similar to that of NTSC-HD. As shown in part (a) of FIG. 8, a period from the first line (LINE 1) to the 20th line is a vertical blanking period, a period from the 21st line (LINE 21) to the 560th line is an active line period of a first field, a period from the 561st line (LINE 561) to the 583rd line is a vertical blanking period, a period from the 584th line (LINE 584) to the 1123rd line is an active line period of a second field, and a period of the 1124th line and the 1125th line is a vertical blanking period. The first field is formed of the first to 563rd lines, and the second field is formed of the 564th to 1125th lines.

As shown in parts (b) and (c) of FIG. 8, one horizontal line data has 3960 clocks, wherein the clock frequency fcl of the transmission clocks VINCLK is 112 MHz, and a period of the first 1080 clocks is set as a horizontal blanking period, and a period of the subsequent 2880 clocks is set as an inter-line effective signal period.

Also in this case, periods of the first and last four clocks in the horizontal blanking period are set as the EAV and SAV codes, respectively, and, as shown in parts (d), (e), and (f) of FIG. 8, desired bit patterns of the status words (XY) are assigned for every horizontal line.

Next, the data format of the PAL-SD transmission data shown in FIG. 9 will be described.

In the PAL-SD frame structure, as shown in part (a) of FIG. 9, the number of horizontal lines forming one frame is 625. A period from the first line (LINE 1) to the 22nd line is a vertical blanking period, a period from the 23rd line (LINE 23) to the 310th line is an active line period of a first field, a period from the 311th line (LINE 311) to the 335th line is a vertical blanking period, a period from the 336th line (LINE 336) to the 623rd line is an active line period of a second field, and a period of the 624th line and the 625th line is a vertical blanking period. The first field is formed of the first to 313th lines, and the second field is formed of the 314th to 625th lines.

In parts (b) and (c) of FIG. 9, the structure of one horizontal line data is illustrated. In FIG. 9, as in FIG. 7, a data segment Ceg corresponds to four clocks and has a frequency of 112 MHz/4, wherein the clock frequency fcl of the transmission clocks VINCLK is 112 MHz, in which the same data is multiplexed four times and transmitted.

One horizontal line has 7128 clocks (=1782×4), in which a period of the first 1368 clocks is set as a horizontal blanking period and a period of the subsequent 5760 clocks is set as an inter-line effective signal period. Periods of the first and last four clocks in the horizontal blanking period are set as the EAV and SAV codes, respectively, and, as shown in parts (d), (e), and (f) of FIG. 9, desired bit patterns of the status words (XY) are assigned for every horizontal line.

In the present embodiment, therefore, the NTSC-HD, NTSC-SD, PAL-HD, and PAL-SD transmission baseband data are transmitted in the CCIR Rec. 656 compliant data formats described above.

Furthermore, in the present embodiment, a frame reference signal serving as a frame timing reference is further inserted in the structure of the data formats shown in FIGS. 6 to 9.

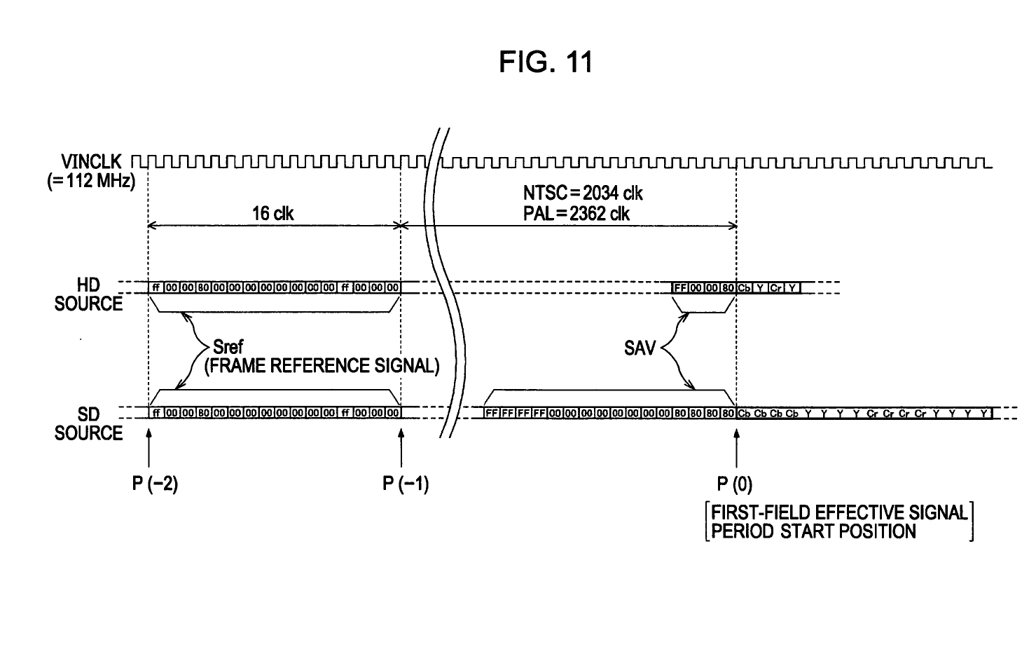

FIG. 11 shows an example of the format in which the frame reference signal is inserted.

In FIG. 11, sequences of HD-source and SD-source transmission baseband data are illustrated in correspondence with cycle timings of the transmission clocks VINCLK having a clock frequency fc1 of 112 MHz.

In FIG. 11, a data position P(0) is an effective signal start position of the first field for each of the HD source and the SD source. The effective signal (effective image) start position of the first field is a start position of the inter-line effective signal period in the first horizontal line of the first field active line period. As a specific example, in the NTSC-HD transmission data shown in FIG. 6, the data position P(0) corresponds to the position of the first 8-bit data (clock unit data) in the inter-line effective signal period, which is located at the 421st clock from the top in the 21st line. In the NTSC-SD transmission data shown in FIG. 7, the data position P(0) corresponds to the position of the first 8-bit data (clock unit data) in the inter-line effective signal period, which is located 1312 clocks or 1012 clocks after the top in the 23rd line. In FIG. 11, the data array of the SAV code arranged immediately before the data position P(0) is illustrated for clarification.

As shown in FIG. 11, a frame reference signal Sref is inserted in a similar manner for the HD and SD sources in a period of 16 clocks from a data position P(−1) a predetermined number of clocks back from the data position P(0) to a data position P(−2).

The position at which the frame reference signal Sref is inserted will be specifically described. The distance from the data position P(0) to the data position P(−1) has 2034 clocks for the NTSC system, and has 2362 clocks for the PAL system. The insertion position of the frame reference signal Sref determined according to the number of clocks is located in the inter-line effective signal period in the last horizontal line among the horizontal lines forming the vertical blanking period of the first field regardless of the NTSC-HD, NTSC-SD, PAL-HD, or PAL-SD transmission data. That is, the frame reference signal Sref is inserted in a period in which invalid signal data for image display is arranged. A bit pattern that does not inherently exist in such a period or region in which the invalid signal data is arranged is assigned to the frame reference signal Sref to allow the frame reference signal Sref to be identified.

The frame reference signal Sref may be inserted at any other position besides that shown in FIG. 11 in the frame data. The distance (the number of clocks) relative to the effective signal start position of the first field is not limited to 2034 or 2362 clocks described above. However, if the insertion position is near the effective signal start position, it is expected that a higher-accuracy synchronization timing can be generated in signal processing performed by a receiving processor (the display-output-system signal processing unit 15).

It is sufficient that the frame reference signal Sref be inserted so that a specific data position within a frame, such as an effective signal start position, can be specified. For example, the frame reference signal Sref may be inserted in the vertical blanking period immediately before the active line period of the second field from the effective signal start position of the second field.

As can be seen from the foregoing description, in the present embodiment, either HD-source or SD-source baseband data has a format in which the baseband data is transmitted by the transmission clocks VINCLK having a common clock frequency fcl of 112 MHz.

With such a transmission format, in the present embodiment, even at the timing when the baseband data is switched between the HD and SD sources during, for example, the transmission of the baseband data via the display-output-system transmission channel 20, the baseband data is switched at the timing in accordance with the same transmission clock, i.e., 112 MHz, without switching the frequencies of the transmission clocks. Therefore, for example, when baseband data is transmitted and output from the transmission output side, the switching from the HD source to the SD source or from the SD source to the HD source is performed in units of frames, thereby ensuring that data is transmitted on a frame-by-frame basis under the same clock rate regardless of whether or not source switching occurs.

Furthermore, in the present embodiment, as described with reference to FIG. 11, the frame reference signal Sref is inserted in the frame structure of the transmission baseband data. In both HD and SD sources, the frame reference signal Sref is inserted at a data position a predetermined number of clocks previous to the effective signal start position of the first field. This ensures that the effective signal start position of the first field can be specified by counting the predetermined number of clocks from the time when the frame reference signal Sref is detected. That is, the frame reference signal Sref is a signal for detecting an inter-frame predetermined reference data position having meaning common to the HD and SD sources at an absolute time in a frame period. For example, upon receiving transmission baseband data, the display-output-system signal processing unit 15 generates a timing signal (control signal), such as a vertical synchronizing signal or a horizontal synchronizing signal, for the HD or SD source on the basis of the detection timing of the frame reference signal Sref, and performs predetermined signal processing to perform suitable signal processing according to, for example, the frame structure of the transmission baseband data shown in any of FIGS. 6 to 9. An image displayed as a result of the processing performed by the display-output-system signal processing unit 15 ensures the vertical synchronization timings even when video signal data is switched between the HD and SD format. No deviation in vertical synchronization timing occurs.

In the present embodiment, therefore, data transmission between the main signal processing unit 12 and the display-output-system signal processing unit 15 is performed by, first, the transmission clocks VINCLK having a frequency common to the HD and SD signal formats, and the frame reference signal Sref is inserted in a frame structure of the transmission baseband data, thus avoiding a distortion in an image displayed on the basis of the signal output from the display-output-system signal processing unit 15.

An example structure of the video camera apparatus 1 compatible with the above-described transmission formats will now be described.

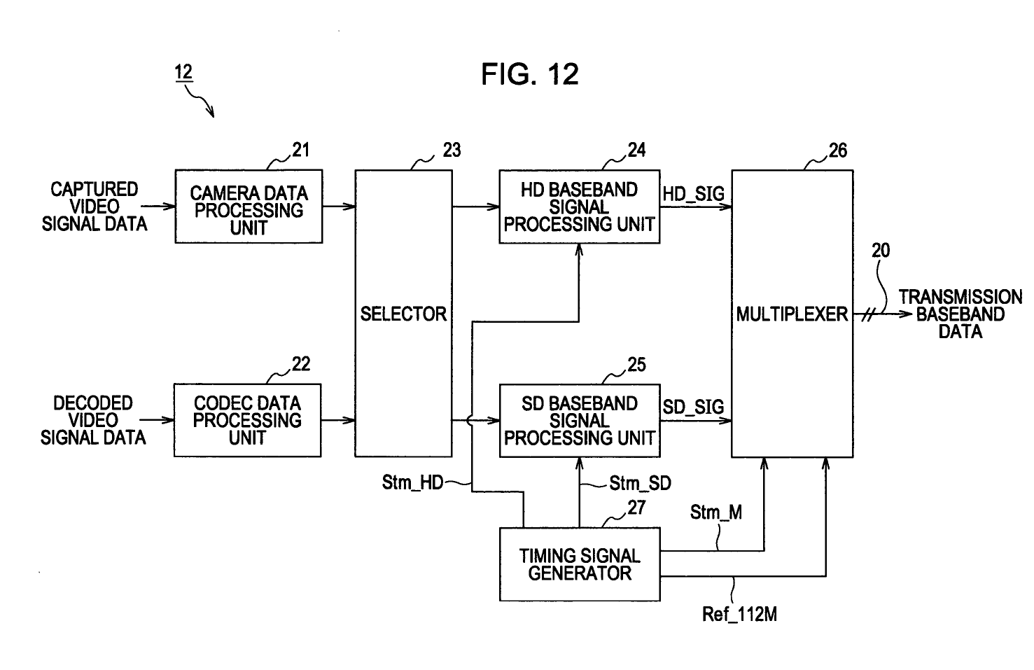

FIG. 12 shows main components of the main signal processing unit 12 for transmitting transmission baseband data to the display-output-system signal processing unit 15. As shown in FIG. 12, the main signal processing unit 12 includes a camera data processing unit 21, a codec data processing unit 22, a selector 23, an HD baseband signal processing unit 24, an SD baseband signal processing unit 25, a multiplexer 26, and a timing signal generator 27.

The camera data processing unit 21 receives captured video signal data output from the camera signal processing unit 11 shown in FIG. 1, and performs signal processing preparatory to, for example, conversion into a baseband signal. The codec data processing unit 22 receives decoded video signal data, which is the decoded (decrypted) video signal output from the codec processing unit 13, and also performs signal processing preparatory to conversion into a baseband signal. Thereby, the captured video signal data from the camera signal processing unit 11 and the decoded video signal data from the codec processing unit 13 are converted into, for example, a common signal format suitable for the subsequent conversion into a baseband signal.

The selector 23 selects a signal input/output path. When a signal of a captured image is output to the display-output-system signal processing unit 15, such as when the operation mode of the video camera apparatus 1 is in an image capture mode, the selector 23 selects the output signal of the camera data processing unit 21 as an input. On the other hand, when a signal based on the image data read from the medium is output to the display-output-system signal processing unit 15, such as when the video camera apparatus 1 is in a playback mode in which the image data recorded on the medium is played back, the selector 23 selects the output signal of the codec data processing unit 22. For example, when the image data is played back from the medium, the compression-encoded data read from the medium is decoded. Therefore, a signal obtained by processing the decoded data is output from the codec data processing unit 22.

When the signal (input signal) input to the selector 23 in the manner described above has an HD-compatible format, the selector 23 outputs the input signal to the HD baseband signal processing unit 24. On the other hand, when the input signal has an SD-compatible format, the selector 23 outputs the input signal to the SD baseband signal processing unit 25.

For example, when an HD-compatible image capture mode for capturing and recording an image in the HD format is set, video signal data is generated in a predetermined HD-compatible signal format at a predetermined stage until the video signal data is output from the camera data processing unit 21, and the HD-compatible signal is input to the selector 23. On the other hand, when an SD-compatible image capture mode for capturing and recording an image in the SD format is set, video signal data is generated in a predetermined SD-compatible signal format until the video signal data is input to the selector 23.

When the image data read from the medium is in the HD format, the signal input to the selector 23 is HD-compatible. When the read image data is in the SD format, the signal input to the selector 23 is SD-compatible.

The HD baseband signal processing unit 24 performs predetermined signal processing to convert the video signal data input from the selector 23 into baseband data on the basis of a timing signal group Stm_HD supplied from the timing signal generator 27. The timing signal group Stm_HD represents a collection of one or more predetermined timing signals.

In the signal processing performed by the HD baseband signal processing unit 24, first, the input video signal data is converted into a signal having the data array of the basic baseband data shown in FIG. 2A. The conversion process is performed using timing signals such as clocks having a frequency of 56 MHz and vertical/horizontal synchronizing signals (vertical/horizontal control signals) synchronized with the clocks. The basic baseband data signal is further converted into a baseband data signal having the data array shown in FIGS. 2B and 4A for the NTSC system or a baseband data signal having the data array shown in FIGS. 2B and 5A for the PAL system. The converted baseband data signal has no codes inserted therein, such as the EAV and SAV codes complying with CCIR Rec. 656 and the frame reference signals Sref. This processing is performed using timing signals such as clocks having a frequency of 112 MHz (the transmission clocks VINCLK) and vertical/horizontal synchronizing signals (vertical/horizontal control signals) synchronized with the clocks, which are compatible with the NTSC-HD or PAL-HD format. The generated baseband data signal is output to the multiplexer 26 as a signal HD_SIG.

The SD baseband signal processing unit 25 performs predetermined signal processing to convert the video signal data input from the selector 23 into baseband data on the basis of a timing signal group Stm_SD supplied from the timing signal generator 27. Like the timing signal group Stm_HD, the timing signal group Stm_SD represents a collection of one or more predetermined timing signals.

In the signal processing performed by the SD baseband signal processing unit 25, first, the input video signal data is converted into a signal having the data array of the basic baseband data shown in FIG. 2A using timing signals such as clocks having a frequency of 13.5 MHz and vertical/horizontal synchronizing signals (vertical/horizontal control signals) synchronized with the clocks. The basic baseband data signal is further converted into a baseband data signal having the data array shown in FIGS. 3B and 4B for the NTSC system or a baseband data signal having the data array shown in FIGS. 3B and 5B for the PAL system. The converted baseband data signal also has no codes inserted therein, such as the EAV and SAV codes and the frame reference signals Sref. This processing is also performed using timing signals such as clocks having a frequency of 112 MHz (the transmission clocks VINCLK) and vertical/horizontal synchronizing signals (vertical/horizontal control signals) synchronized with the clocks, which are compatible with the NTSC-SD or PAL-SD format. The generated baseband data signal is output to the multiplexer 26 as a signal SD_SIG.

The multiplexer 26 receives the signal HD_SIG or SD_SIG. The multiplexer 26 uses a timing signal group Stm_M supplied from the timing signal generator 27 and a reference frame signal Ref_112M synchronized with 112-MHz clocks in the timing signal group Stm_M to perform signal processing for generating transmission baseband data and transmitting the transmission baseband data.

In the signal processing, when the signal HD_SIG corresponding to the NTSC-HD source is input to the multiplexer 26, the signal HD_SIG is converted into transmission baseband data having the frame structure shown in FIG. 6. This frame structure is obtained by inserting the bit patterns of the SAV and EAV codes shown in FIG. 6. A code of the frame reference signal Sref is further inserted at the data position shown in FIG. 11. The signal obtained as a result of such signal processing is output as transmission baseband data from the 8-bit parallel display-output-system transmission channel 20 in synchronization with 112-MHz transmission clocks. At this time, timing signals such as clocks having a frequency of 112 MHz and NTSC-HD compatible horizontal/vertical control signals synchronized with the clocks are used.

When the signal SD_SIG corresponding to the NTSC-SD source is input to the multiplexer 26, the signal SD_SIG is converted into transmission baseband data having the frame structure shown in FIG. 7, and a code of the frame reference signal Sref is inserted at the data position shown in FIG. 11. The resulting signal is output as transmission baseband data from the display-output-system transmission channel 20. This processing is performed using timing signals such as clocks having a frequency of 112 MHz and NTSC-SD compatible horizontal/vertical control signals synchronized with the clocks.

When the signal HD_SIG corresponding to the PAL-HD source is input to the multiplexer 26, the signal HD_SIG is converted into transmission baseband data having the frame structure shown in FIG. 8, and a code of the frame reference signal Sref is inserted. The resulting signal is output as transmission baseband data from the display-output-system transmission channel 20. When the signal SD_SIG corresponding to the PAL-SD source is input to the multiplexer 26, the signal SD_SIG is converted into transmission baseband data having the frame structure shown in FIG. 9, and a code of the frame reference signal Sref is inserted. The resulting signal is output as transmission baseband data from the display-output-system transmission channel 20.

At this time, timing signals such as clocks having a frequency of 112 MHz and PAL-HD or PAL-SD compatible horizontal/vertical control signals synchronized with the clocks are used.

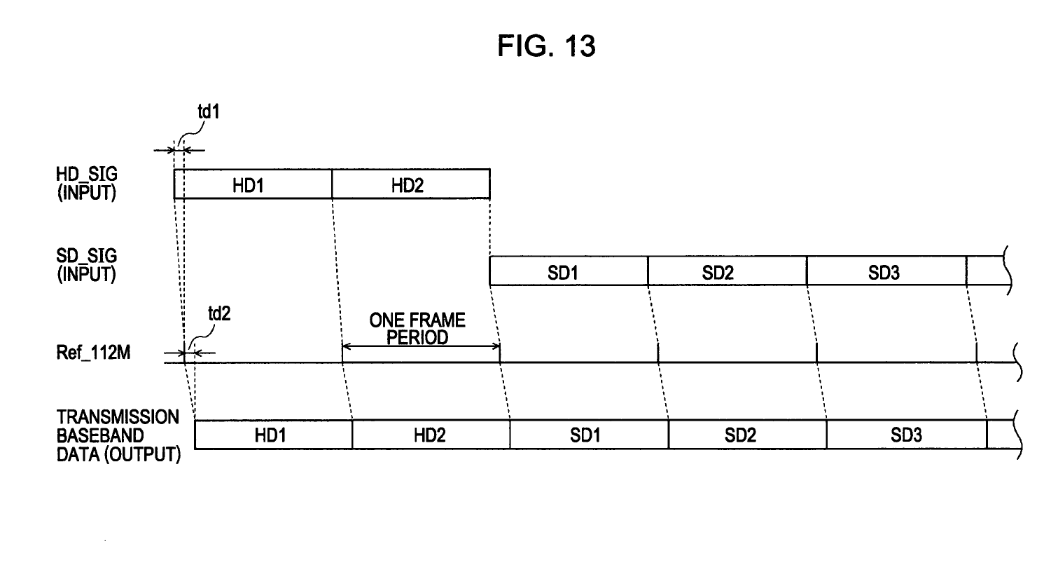

FIG. 13 shows an operation timing of the main signal processing unit 12 having the structure shown in FIG. 12 at which the source to be transmitted as transmission baseband data is switched from HD to SD.

For example, the source to be transmitted to the display output system is switched from HD to SD. That is, for example, the signal format of the image data played back from the medium is switched from HD to SD and the signal format of the decoded video signal data is also switched from HD to SD accordingly. Alternatively, for example, the setting of quality of a captured image is changed from HD to SD during the image capturing and recording mode; the display of a monitor image in the HD-compatible image capture mode is changed to the playback and display of image data read from the medium in the SD format; or conversely, the display of a playback image in the SD format is changed to the display of a monitor image in SD-compatible image capture mode.

In accordance with the above-described switching of the signal format from HD to SD, the selector 23 switches the input, if necessary, and switches the signal output from the HD-source signal being currently output to the HD baseband signal processing unit 24 to the SD-source signal output to the SD baseband signal processing unit 25. As a result, as shown in FIG. 13, frame data HD1 and HD2 input as the signal HD_SIG, followed by frame data SD1, SD2, SD3, and so on input as the signal SD_SIG, are input to the multiplexer 26.

As shown in FIG. 13, the frame synchronization timing of the reference frame signal Ref_112M supplied to the multiplexer 26 is delayed by a time td1 with respect to the frame synchronization timing of the signal HD_SIG or SD_SIG input to the multiplexer 26.

As described above, the multiplexer 26 performs signal processing for generating transmission baseband data according to the reference frame signal Ref_112M having the above-described frame synchronization timing, and transmits the resulting signal at the time synchronized with 112-MHz transmission clocks. When the signal input to the multiplexer 26 is switched from the HD source to the SD source in the manner shown in FIG. 13, the frame data HD1, HD2, SD1, SD2, and SD3 of the transmission baseband data shown in FIG. 13 are consecutively output from the multiplexer 26 in the order stated above according to the frame synchronization timing corresponding to the reference frame signal Ref_112M. Due to the internal processing time of the multiplexer 26, the frame data of the transmission baseband data output from the multiplexer 26 is delayed by a time td2 with respect to the frame synchronization timing corresponding to the reference frame signal Ref_112M.

It is to be understood that, also in the case where the signal is switched from the SD source to the HD source, the switching from the SD source to the HD source is performed in a manner similar to that shown in FIG. 13 so that the frame data can be consecutively output.

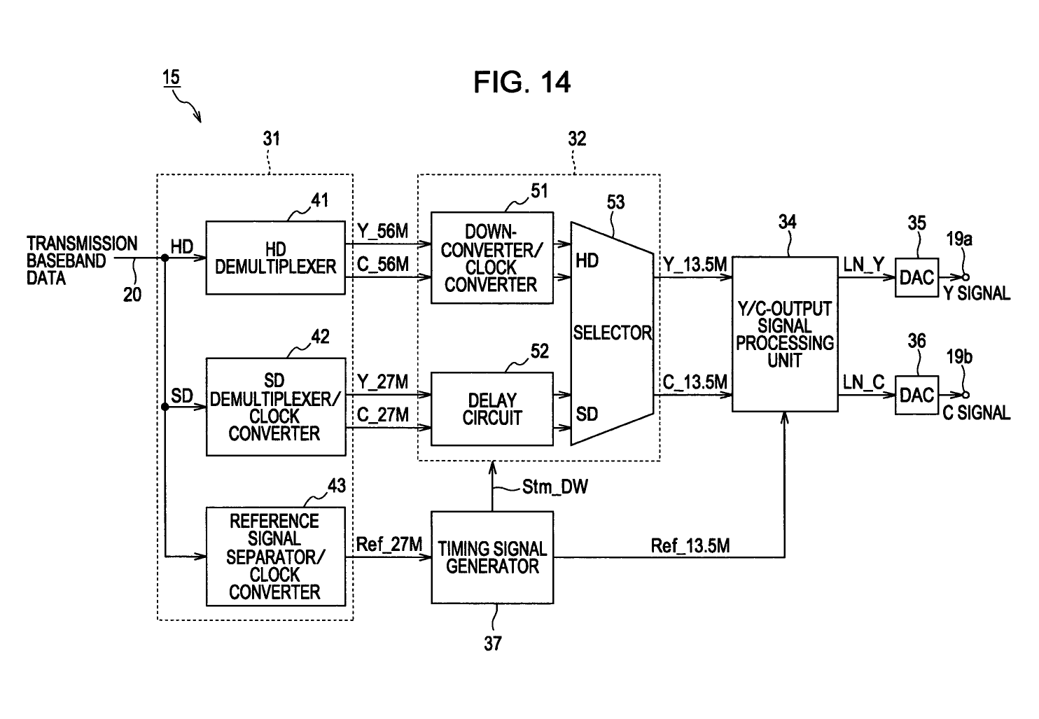

FIG. 14 shows an example internal structure of the display-output-system signal processing unit 15. In FIG. 14, for ease of illustration, a system for outputting separate Y and C signals from the LINE OUT terminal 19 is illustrated.

The transmission baseband data transmitted via the display-output-system transmission channel 20 is first input to an input processing unit 31.

As shown in FIG. 14, the input processing unit 31 includes an HD demultiplexer 41, an SD demultiplexer/clock converter 42, and a reference signal separator/clock converter 43. The transmission baseband data is input to the HD demultiplexer 41, the SD demultiplexer/clock converter 42, and the reference signal separator/clock converter 43.

When the input transmission baseband data is the HD source, the HD demultiplexer 41 receives the transmission baseband data, and obtains brightness signal data Y and color difference signal data (Cb and Cr) in the HD-compatible basic baseband data format synchronized with 56-MHz clocks.

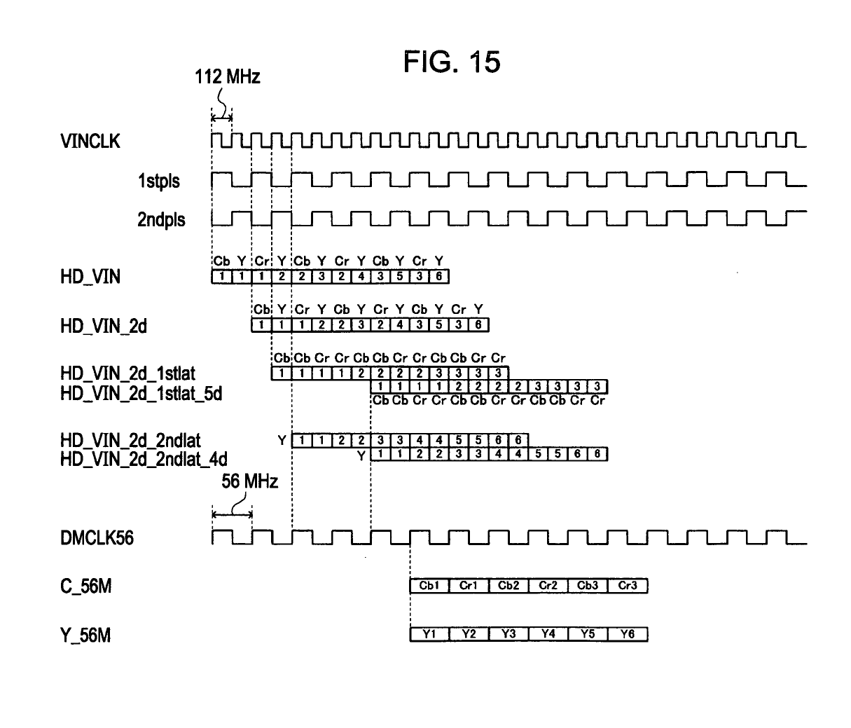

FIG. 15 is a timing chart showing an example of the signal processing performed by the HD demultiplexer 41.

In FIG. 15, an input signal HD_VIN represents the HD-source signal input to the HD demultiplexer 41. As shown in FIG. 15, the input signal HD_VIN is input in synchronization with the transmission clocks VINCLK having a clock frequency fcl of 112 MHz. That is, the color difference signal data Cb, the brightness signal data Y, the color difference signal data Cr, and the brightness signal data Y, each having eight bits, are repeatedly input in the order stated above at every cycle (or clock) of the transmission clocks VINCLK. It is to be understood that the relationship between the input signal HD_VIN and the transmission clocks VINCLK is based on the data array shown in FIG. 2B.

The HD demultiplexer 41 further generates, from the transmission clocks VINCLK, two timing signals (timing pulses) 1stpls and 2ndpls synchronized with a half frequency (i.e., 56 MHz) relative to the frequency of the transmission clocks VINCLK on the basis of the timings of the SAV and EAV codes detected from the input signal HD_VIN. The timing signals 1stpls and 2ndpls are generated so as to have a phase difference of 180° from each other. In connection with the input signal HD_VIN, a high-level pulse of the timing signal 1stpls coincides with the timing of the color difference signal data Cb and Cr, and a high-level pulse of the timing signal 2ndpls coincides with the timing of the brightness signal data Y.

The HD demultiplexer 41 delays the input signal HD_VIN by two steps (two clocks) using the transmission clocks VINCLK to generate a signal HD_VIN_2d. The signal HD_VIN_2d is latched by the high-level pulse of the timing signal 1stpls to obtain an output signal HD_VIN_2d_1stlat. As shown in FIG. 15, the signal HD_VIN_2d_1stlat provides the color difference signal data Cb and Cr at every two clocks of the transmission clocks VINCLK (fcl=112 MHz). That is, the color difference signal data Cb and Cr are extracted at this stage from the input signal HD_VIN. The signal HD_VIN_2d_1stlat is delayed by five steps (five clocks) using the transmission clocks VINCLK (fcl=112 MHz) to determine signal timing as a signal HD_VIN_2d_1stlat_5d.

The HD demultiplexer 41 also latches the signal HD_VIN_2d at the time of the high-level pulse of the timing signal 2ndpls to output a signal HD_VIN_2d_2ndlat by which the brightness signal data Y is extracted from the input signal HD_VIN. The signal HD_VIN_2d_2ndlat is delayed by four steps (four clocks) using the transmission clocks VINCLK (fcl=112 MHz) to determine a signal timing as a signal HD_VIN_2d_2ndlat_4d.

With the above-described processing, the color difference signal data Cb and Cr and the brightness signal data Y are separately extracted from the input signal HD_VIN, and the timing of the color difference signal data Cb and Cr and the timing of the brightness signal data Y coincide with each other, as indicated by the signals HD_VIN_2d_1stlat_5d and HD_VIN_2d_2ndlat_4d.

The HD demultiplexer 41 divides the frequency of the transmission clocks VINCLK (fcl=112 MHz) into two to generate clocks DMLCK56 (56 MHz), and the clocks DMLCK56 are used to synchronize the signals HD_VIN_2d_1stlat_5d and HD_VIN_2d_2ndlat_4d. As a result, as shown in FIG. 15, sequences of color difference signal data (Cb and Cr) and brightness signal data Y, each having eight bits for every clock, can be obtained in synchronization with the clocks DMLCK56 having a frequency of 56 MHz. The sequences of color difference signal data and brightness signal data are represented by signals C_56M and Y_56M, respectively, and are obtained as outputs of the HD demultiplexer 41. The signals C_56M and Y_56M are compatible with the HD-source basic baseband data format shown in FIG. 2A.

The SD demultiplexer/clock converter 42 includes a demultiplexer and a clock converter following the demultiplexer. Upon receiving the SD-source transmission baseband data, the demultiplexer obtains brightness signal data Y and color difference signal data (Cb and Cr) synchronized with the 56-MHz clocks, which are compatible with the format shown in FIG. 3A. The brightness signal data Y and color difference signal data (Cb and Cr) synchronized with the 56-MHz clocks is further subjected to clock conversion for synchronization with 27-MHz clocks.

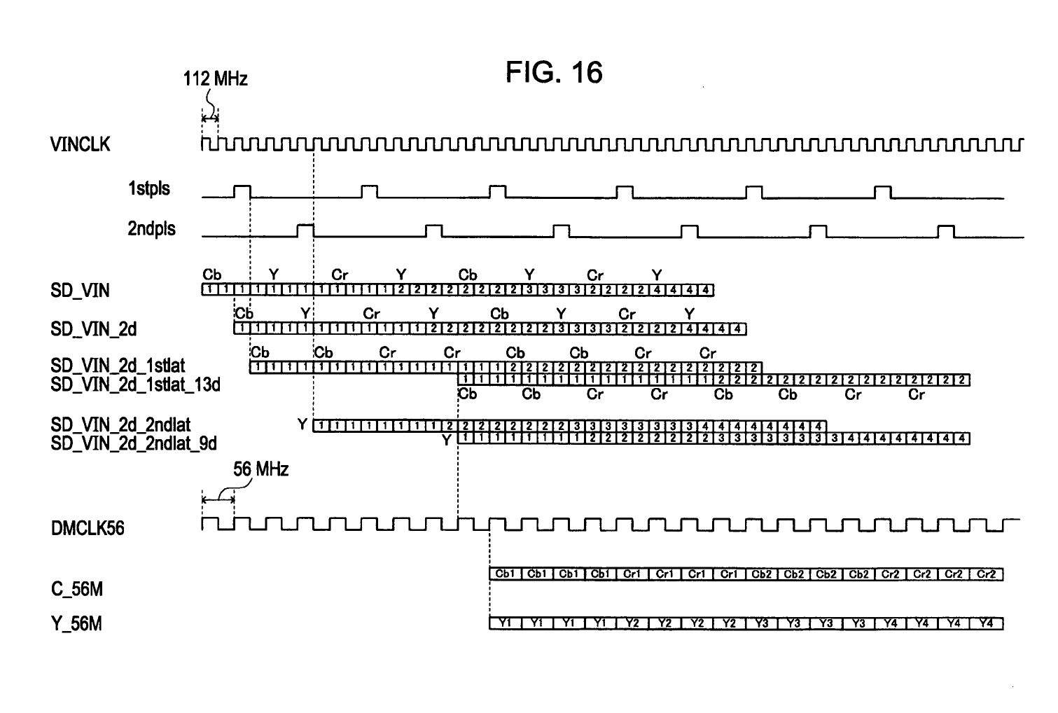

FIG. 16 is a timing chart showing an example of the signal processing performed by the demultiplexer in the SD demultiplexer/clock converter 42.

As shown in FIG. 16, an input signal SD_VIN, which is an SD-source signal input to the demultiplexer of the SD demultiplexer/clock converter 42, is input so that the color difference signal data Cb, the brightness signal data Y, the color difference signal data Cr, and the brightness signal data Y are repeatedly input in the order stated above at every four clocks of the transmission clocks VINCLK having a clock frequency fcl of 112 MHz. That is, the input signal SD_VIN having the data array shown in FIG. 3B is multiplexed four times and transmitted at every consecutive four clock cycles each carrying 8-bit data.

Timing signals 1stpls and 2ndpls are generated on the basis of the timings of the SAV and EAV codes detected from the input signal SD_VIN so as to be synchronized with a ⅛ frequency (i.e., 14 MHz) relative to the frequency of the transmission clocks VINCLK. The timing signals 1stpls and 2ndpls also have a phase difference of 180° from each other. In connection with the input signal SD_VIN, a high-level pulse of the timing signal 1stpls coincides with the third timing in the four-time-multiplexed sequence of color difference signal data Cb and Cr, and a high-level pulse of the timing signal 2ndpls coincides with the third timing in the four-time-multiplexed sequence of brightness signal data Y.

The demultiplexer of the SD demultiplexer/clock converter 42 delays the input signal SD_VIN by two steps (two clocks) using the transmission clocks VINCLK to generate a signal SD_VIN_2d, and latches the signal SD_VIN_2d by the high-level pulse of the timing signal 1stpls to obtain a signal SD_VIN_2d_1stlat. Therefore, the color difference signal data Cb and Cr are extracted from the input signal SD_VIN. The signal SD_VIN_2d_1stlat is delayed by 13 steps (13 clocks) using the transmission clocks VINCLK (fcl=112 MHz) to determine a signal timing as a signal SD_VIN_2d_1stlat_13d.

The brightness signal data Y is extract from the input signal SD_VIN by latching the signal SD_VIN_2d at the time of the high-level pulse of the timing signal 2ndpls to obtain a signal SD_VIN_2d_2ndlat. The signal SD_VIN_2d_2ndlat is delayed by nine steps (nine clocks) using the transmission clocks VINCLK (fcl=112 MHz) to determine a signal timing as a signal SD_VIN_2d_2ndlat_9d.

In this way, the signals SD_VIN_2d_1stlat_13d and SD_VIN_2d_2ndlat_9d are obtained. Therefore, the color difference signal data Cb and Cr and the brightness signal data Y are separately extracted from the input signal SD_VIN, and the timing of the color difference signal data Cb and Cr and the timing of the brightness signal data Y coincide with each other.

The demultiplexer of the SD demultiplexer/clock converter 42 divides the frequency of the transmission clocks VINCLK (fcl=112 MHz) into two to generate clocks DMLCK56 (56 MHz), and the clocks DMLCK56 are used to synchronize the signals SD_VIN_2d_1stlat_13d and SD_VIN_2d_2ndlat_9d. As a result, as shown FIG. 16, a sequence of 8-bit color difference signal data (Cb and Cr) multiplexed four times at every four clocks, and a sequence of brightness signal data Y multiplexed four times at every four clocks are obtained as signals C_56M and Y_56M, respectively, in parallel in synchronization with the clocks DMLCK56 with 56 MHz. The signals C_56M and Y_56M are compatible with the baseband data format synchronized with the 56-MHz clocks shown in FIG. 3A.

Then, the demultiplexer of the SD demultiplexer/clock converter 42 outputs the obtained signals C_56M and Y_56M to the clock converter of the SD demultiplexer/clock converter 42. The clock converter latches the input signals C_56M and Y_56M at predetermined timings in accordance with 27-MHz clocks to generate signals C_27M and Y_27M synchronized with the 27-MHz clocks, including the color difference signal data (Cb and Cr) and the brightness signal data Y, respectively. The signals C_27M and Y_27M are in a 16-bit parallel format in which 8-bit brightness signal data Y and 8-bit color difference signal data (Cb and Cr) are obtained at every clock of the 27-MHz clocks. The signals C_27M and Y_27M are output from the SD demultiplexer/clock converter 42.

Referring to FIG. 14, upon receiving the transmission baseband data, the reference signal separator/clock converter 43 in the input processing unit 31 detects the frame reference signal Sref shown in FIG. 11.

As can be seen from FIG. 11, the detected frame reference signal Sref is a signal indicating the effective signal period of the first field in each frame data under the transmission clocks VINCLK with 112 MHz. The reference signal separator/clock converter 43 performs clock exchange (or clock conversion) processing to generate an internal frame reference signal Ref_27M in which the frame reference signal Sref is synchronized with the 27-MHz clocks. The internal frame reference signal Ref_27M is a signal indicating the effective signal period of the first field under a clock timing of 27 MHz. The reference signal separator/clock converter 43 outputs the internal frame reference signal Ref_27M to a timing signal generator 37.

The timing signal generator 37 uses the internal frame reference signal Ref_27M to generate a timing signal group Stm_DW to be supplied to a down-converter 32 and an internal frame reference signal Ref_13.5M to be supplied to an Y/C-output signal processing unit 34.

The signals C_56M and Y_56M output from the HD demultiplexer 41 are input to a down-converter/clock converter 51 in the down-converter 32. The signals C_27M and Y_27M output from the SD demultiplexer/clock converter 42 are input to a delay circuit 52 in the down-converter 32.

The signals C_56M and Y_56M input to the down-converter/clock converter 51 are HD signals having the frame structure shown in FIG. 4A for the NTSC system or the frame structure shown in FIG. 5A for the PAL system. The down-converter/clock converter 51 performs down-conversion for converting the HD signals C_56M and Y_56M into the SD-compatible frame structure shown in FIG. 4B or 5B. The down-conversion process can be performed using a known signal processing technique. As well as the down-conversion process, clock exchange into the 27-MHz clocks (or 13.5-MHz clocks) is performed on the signal having the SD-compatible frame structure.

In the down-conversion process, for example, the internal frame reference signal Ref_27M generated on the basis of the frame reference signal Sref inserted in the transmission baseband data can be effectively used. That is, in the conversion into the SD format by down-conversion, for example, the timing of the vertical blanking period and the horizontal blanking period can be correctly determined on the basis of the timing of the effective signal start position of the first field under a 27-MHz clock environment specified by the internal frame reference signal Ref_27M.

Accordingly, the brightness signal data and color difference signal data subjected to down-conversion and clock exchange by the down-converter/clock converter 51 are input to a selector 53.

The processing performed by the down-converter/clock converter 51 has a comparatively large load, and takes a processing time longer than the HD demultiplexer 41 and the SD demultiplexer/clock converter 42. Therefore, after the transmission baseband data is input to the input processing unit 31, the signal output through the HD-compatible processing by the HD demultiplexer 41 and the down-converter/clock converter 51 is significantly delayed with respect to the signal output through the SD-compatible processing by the SD demultiplexer/clock converter 42. That is, an output time difference occurs.

The signals C_27M and Y_27M output from the SD demultiplexer/clock converter 42 are in the SD format and are signals synchronized with the 27-MHz clocks, and there is no need for down-conversion and clock exchange processing. However, it is necessary to cancel out the output time difference described above in the HD source system to match between the frame synchronization timings of the HD and SD sources.

The delay circuit 52 determines a delay time corresponding to the output time difference in the HD-source system, and outputs the signals C_27M and Y_27M with delay to the selector 53. Therefore, the frame synchronization timings of the SD signal obtained by down-converting the HD signal (hereinafter referred to as a “down-converted SD signal”) and the SD signal output from the delay circuit 52 without being down-converted (hereinafter referred to as a “delayed SD signal”) coincide with each other when the down-converted SD signal and the delayed SD signal are input to the selector 53.

The selector 53 receives either the down-converted SD signal or the delayed SD signal. The selector 53 selects the input signal and synchronizes the selected signal with 13.5-MHz clocks to generate signals Y_13.5M and C_13.5M. The selector 53 outputs the signals Y_13.5M and C_13.5M to the Y/C-output signal processing unit 34.

The Y/C-output signal processing unit 34 performs signal processing on the signals Y_13.5M and C_13.5M input from the selector 53 to generate signals LN_Y and LN_C, which are digital Y and C signals corresponding to the separate Y and C signals to be output from the LINE OUT terminal 19, and outputs the signals LN_Y and LN_C. The signals LN_Y and LN_C are generated using the internal frame reference signal Ref_13.5M supplied from the timing signal generator 27. The internal frame reference signal Ref_13.5M is generated by the timing signal generator 27 on the basis of the internal frame reference signal Ref_27M. Therefore, the signals LN_Y and LN_C whose vertical blanking periods are correctly set can be obtained.

The LINE OUT terminal 19 outputs analog separate Y and C signals. Actually, the LINE OUT terminal 19 includes terminals 19a and 19b corresponding to the Y and C signals, respectively. The signals LN_Y and LN_C are converted into analog signals by digital-to-analog (D/A) converters 35 and 36, respectively, and the analog Y and C signals are output from the terminals 19a and 19b, respectively.

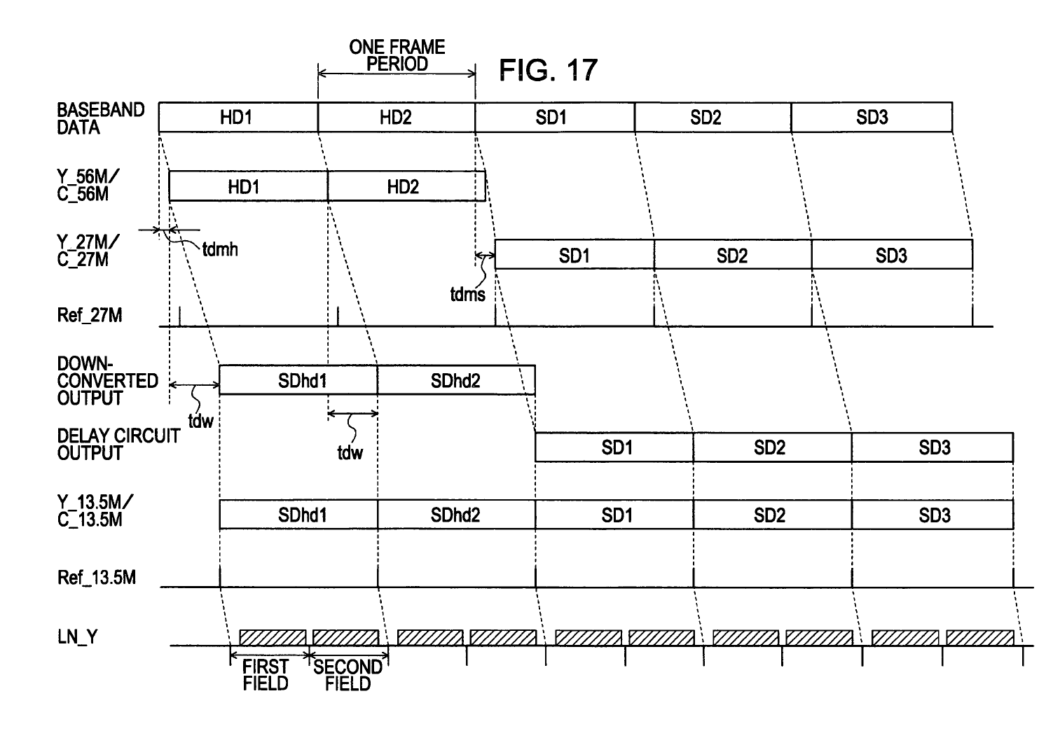

FIG. 17 is a timing chart showing an example of the signal processing operation of the display-output-system signal processing unit 15 having the structure shown in FIG. 14 when the transmission baseband data input via the display-output-system transmission channel 20 is switched from the HD source to the SD source.

In FIG. 17, transmission baseband data is input to the input processing unit 31 of the display-output-system signal processing unit 15 so that frame data HD1, HD2, SD1, SD2, SD3, and so on are input in the order stated above. The frame data HD1 and HD2 are the HD sources, and the frame data SD1, SD2, SD3, and so on are the SD sources. That is, the source changes to the SD source at the frame data subsequent to the frame data HD2. The input transmission baseband data shown in FIG. 17 corresponds to that shown in FIG. 13.

According to the structure shown in FIG. 14, the HD-source transmission baseband data input to the input processing unit 31 is output by the HD demultiplexer 41 as signals C_56M and Y_56M. In FIG. 17, first, the frame data HD1 and HD2 of the transmission baseband data are output as signals C_56M and Y_56M. The frame data HD1 and HD2 output as the signals C_56M and Y_56M are delayed by a time tdmh, which corresponds to the signal processing time of the HD demultiplexer 41, with respect to the frame data HD1 and HD2 of the transmission baseband data.

The SD-source frame data SD1, SD2, SD3, and so on input after the frame data HD2 of the transmission baseband data are output by the SD demultiplexer/clock converter 42 as signals C_27M and Y_27M. The frame data SD1, SD2, SD3, and so on output as the signals C_27M and Y_27M are delayed by a time tdms, which corresponds to the signal processing time of the SD demultiplexer/clock converter 42, with respect to the transmission baseband data.

In response to the input of the transmission baseband data, the reference signal separator/clock converter 43 outputs an internal frame reference signal Ref_27M based on the frame reference signal Sref extracted from the frame data. As shown in FIG. 17, the frame synchronization timing of the internal frame reference signal Ref_27M is synchronous with, for example, the frame timing of the signals C_27M and Y_27M. The number of clocks for one frame period of the internal frame reference signal Ref_27M is given by 858×525×2=900900 under the NTSC system, and 864×625×2=10800 under the PAL system. The frame synchronization timing of the internal frame reference signal Ref_27M is based on the timing of the frame reference signal Sref inserted in the original input transmission baseband data, and ensures constant intervals without being deviated even by switching the format between the HD and SD formats.

Upon receiving the signals C_56M and Y_56M, the down-converter/clock converter 51 performs down-conversion and clock exchange into 27-MHz clocks to generate a down-converted SD signal. As shown in FIG. 17, frame data SDhd1 and SDhd2 of the down-converted SD signal corresponding to the frame data HD1 and HD2 are output at timings delayed by a time tdw, which corresponds to the signal processing time of the down-converter/clock converter 51, with respect to the frame data HD1 and HD2 of the signals C_56M and Y_56M, respectively.

The frame data SD1, SD2, and SD3 of the SD-source signals C_27M and Y_27M converted from the transmission baseband data are also output with a delay of a delay time td1 set in the delay circuit 52. The delay time td1 is determined by the following equation:
tdl=(tdmh+tdw)−tdms

As a result of the delayed output of the signals C_27M and Y_27M in the above-described manner, the timing at which the frame data SD1 output from the delay circuit 52 is started after the end of the frame data SDhd2 of the down-converted SD signal can be obtained. As shown in FIG. 17, the signals Y_13.5M and C_13.5M output from the selector 53 are consecutive in the order of the frame data SDhd1, SDhd2, SD1, SD2, SD3, and so on. That is, even after the HD sources are down-converted, there are no gaps between or no overlapping of the frame data before and after HD/SD switching. Therefore, normal continuity of the frame data can be maintained.

The Y/C-output signal processing unit 34 performs signal processing on, for example, the signals Y_13.5M and C_13.5M to generate signals LN_Y and LN_C, which are digital Y and C signals, at the timing based on the internal frame reference signal Ref_13.5M. In FIG. 17, the signal LN_Y is illustrated. The signal LN_Y is output for a frame period with delay by a processing time for generating the signal LN_Y with respect to the timing of the frame period indicated by the internal frame reference signal Ref_13.5M. In this case, the signal LN_Y is an interlaced signal in which one frame period includes a first field signal period and a second field signal period. In the present embodiment, the timing of the signal LN_Y also ensures the timing of the frame period of the video signal (vertical synchronizing signal timing) regardless of switching of the HD and SD formats.

Although not shown in FIG. 14, the display-output-system signal processing unit 15 further includes a signal system for outputting Y/Pb/Pr digital video signal data to the D-terminal 18 and signal systems for outputting R/G/B display video signal data to the display unit 16 and the viewfinder 17. Those signal systems are have a structure similar to that shown in FIG. 14, and is configured such that signals can be output so that frames are correctly consecutive regardless of switching of the transmission baseband data between the HD and SD formats.

In the signal system for the D-terminal 18, in place of the Y/C-output signal processing unit 34 shown in FIG. 14, for example, a signal processing unit for converting the input signals Y_13.5M and C_13.5M into Y/Pb/Pr digital video signal data may be provided. The Y/Pb/Pr digital video signal data obtained by the signal processing unit may be output from the D-terminal 18.

In the signal systems for outputting R/G/B display video signal data to the display unit 16 and the viewfinder 17, in place of the Y/C-output signal processing unit 34, a signal processing unit for converting the input signals Y_13.5M and C_13.5M into R/G/B display video signal data with a resolution suitable for the screen size of the display unit 16 or the viewfinder 17 may be provided. The signals obtained by the signal processing unit are output to the display unit 16 or the viewfinder 17.

In the foregoing description of the embodiment, by way of example, Y/Cb/Cr baseband data (baseband signal) with a ratio of 4:2:2 in the HD and SD formats is transmitted by transmission clocks with 112 MHz, which is a twice the frequency of the data clocks of the HD basic baseband data. However, in an environment where there is no need to reduce the number of bits (the number of pin terminals) of the transmission channel (the display-output-system transmission channel 20), the baseband data may be transmitted at a frequency of 56 MHz, which is equal to the frequency of the transmission clocks of the HD basic baseband data.

Conversely, a clock frequency higher than 112 MHz, for example, a clock frequency obtained by multiplying 56 MHz by a factor, which is a power of 2, such as 224 MHz or 448 MHz, may be used. As the clock frequency of the transmission clocks increases, the number of bits of the transmission channel decreases correspondingly. The present invention can be extensively applied not only to as parallel transmission but also to serial transmission. Therefore, while in the present embodiment, transmission complying with CCIR Rec. 656 is performed, any other transmission standard specified for each of parallel transmission and serial transmission may be used.

The baseband data format is not limited to a Y/Cb/Cr format with a ratio of 4:2:2, and any other sampling ratio such as 4:1:1 or 4:2:0 may be used. Any other signal format such as Y/Pb/Pr or R/G/B may be used.

While it is assumed herein that the signal format is switched between the HD format and the SD format under the NTSC system or the PAL system, any other television system besides NTSC and PAL may be used. The two signal formats (image quality formats), namely, the HD and SD formats, are currently specified. For example, if more than two image quality formats are specified in the future, the structure according to the embodiment of the present invention can support the switching between the more than two formats.

In the transmission of the frame reference signal Sref, instead of inserting the frame reference signal Sref in the transmission video signal data, the display-output-system transmission channel 20 may further include an additional line for transmitting the frame reference signal Sref. The frame reference signal Sref may be transmitted and output via the additional line at a timing similar to that shown in FIG. 11 in synchronization with the transmission of the transmission video signal data. In this case, the circuit structure for separating the frame reference signal Sref from the transmission video signal data can be removed from the receiver of the transmission video signal data (the display-output-system signal processing unit 15).

In the embodiment, by way of example, video signal transmission is performed between LSI devices serving as the main signal processing unit 12 and the display-output-system signal processing unit 15 in an apparatus serving as the video camera apparatus 1. For example, video signal transmission may be transmitted between different individual apparatuses.

In the video signal transmission, a baseband signal is transmitted to the display-output signal processing system. Alternatively, for example, data transmission to the recording signal processing system may be performed.

While the embodiment is implemented as a video camera apparatus, other apparatuses for processing video signals, such as a television receiver and a video recorder, and a system including a plurality of apparatuses, also fall within the scope of the present invention.

It should be understood by those skilled in the art that various modifications, combinations, sub-combinations and alterations may occur depending on design requirements and other factors insofar as they are within the scope of the appended claims or the equivalents thereof.

1. A video signal processing apparatus comprising:
format converting means for, upon receiving video signal data for which format switching can occur between a plurality of formats, converting the video signal data into transmission video signal data, the transmission video signal data being formatted such that the transmission video signal data is synchronized with clocks having a fixed frequency common to the plurality of formats and that the number of clocks corresponding to one frame determined according to the frequency of the clocks is the same regardless of the plurality of formats of the video signal data;
frame reference signal inserting means for inserting a frame reference signal in each frame of the transmission video signal data obtained by the format converting means to specify a predetermined reference data position in the frame;
transmission output processing means for transmitting and outputting the transmission video signal data having the inserted frame reference signals in synchronization with the clocks on a frame-by-frame basis; and
signal output processing means for, upon receiving the transmission video signal data transmitted and output by the transmission output processing means, performing signal processing for converting the transmission video signal data into a desired video signal format and outputting the converted transmission video signal data, wherein the signal processing is performed in synchronization with frame period timings generated on the basis of the frame reference signals inserted in the received transmission video signal.

2. A video signal processing apparatus comprising:
format converting means for, upon receiving video signal data for which format switching can occur between a plurality of formats, converting the video signal data into transmission video signal data, the transmission video signal data being formatted such that the transmission video signal data is synchronized with clocks having a fixed frequency common to the plurality of formats and that the number of clocks corresponding to one frame determined according to the frequency of the clocks is the same regardless of the plurality of formats of the video signal data;
frame reference signal inserting means for inserting a frame reference signal in each frame of the transmission video signal data obtained by the format converting means to specify a predetermined reference data position in the frame;
transmission output processing means for transmitting and outputting the transmission video signal data having the inserted frame reference signals to another apparatus in synchronization with the clocks on a frame-by-frame basis.

3. The video signal processing apparatus according to claim 2, wherein the predetermined reference data position comprises an effective image period start position at which a predetermined effective image period within the frame starts, and
the frame reference signal inserting means inserts the frame reference signal at a data position a predetermined number of clocks previous or subsequent to the effective image period start position.

4. A video signal processing apparatus comprising:
inputting means for inputting transmission video signal data transmitted and output from another apparatus, the transmission video signal data being generated by converting video signal data for which format switching can occur between a plurality of formats, the transmission video signal data being formatted such that the transmission video signal data is synchronized with clocks having a fixed frequency common to the plurality of formats and that the number of clocks corresponding to one frame determined according to the frequency of the clocks is the same regardless of the plurality of formats of the video signal data, the transmission video signal data having a frame reference signal inserted in each frame thereof to specify a predetermined reference data position in the frame; and
signal output processing means for performing signal processing for converting the transmission video signal data input by the inputting means into a desired video signal format and outputting the converted transmission video signal data, wherein the signal processing is performed in synchronization with frame period timings generated on the basis of the frame reference signals inserted in the input transmission video signal data.

5. A video signal processing method comprising:
upon receiving video signal data for which format switching can occur between a plurality of formats, converting the video signal data into transmission video signal data, the transmission video signal data being formatted such that the transmission video signal data is synchronized with clocks having a fixed frequency common to the plurality of formats and that the number of clocks corresponding to one frame determined according to the frequency of the clocks is the same regardless of the plurality of formats of the video signal data;
inserting a frame reference signal in each frame of the obtained transmission video signal data to specify a predetermined reference data position in the frame;
transmitting and outputting the transmission video signal data having the inserted frame reference signals in synchronization with the clocks on a frame-by-frame basis; and
upon receiving the transmitted and output transmission video signal data, performing signal processing for converting the transmission video signal data into a desired video signal format and outputting the converted transmission video signal data, wherein the signal processing is performed in synchronization with frame period timings generated on the basis of the frame reference signals inserted in the received transmission video signal.

6. A video signal processing method comprising:
upon receiving video signal data for which format switching can occur between a plurality of formats, converting the video signal data into transmission video signal data, the transmission video signal data being formatted such that the transmission video signal data is synchronized with clocks having a fixed frequency common to the plurality of formats and that the number of clocks corresponding to one frame determined according to the frequency of the clocks is the same regardless of the plurality of formats of the video signal data;
inserting a frame reference signal in each frame of the obtained transmission video signal data to specify a predetermined reference data position in the frame;
transmitting and outputting the transmission video signal data having the inserted frame reference signals to another apparatus in synchronization with the clocks on a frame-by-frame basis.

7. A video signal processing method comprising:
inputting transmission video signal data transmitted and output from another apparatus, the transmission video signal data being generated by converting video signal data for which format switching can occur between a plurality of formats so as to be synchronized with clocks having a fixed frequency common to the plurality of formats and so that the number of clocks corresponding to one frame determined according to the frequency of the clocks is the same regardless of the plurality of formats of the video signal data, the transmission video signal data having a frame reference signal inserted in each frame thereof to specify a predetermined reference data position in the frame; and
performing signal processing for converting the input transmission video signal data into a desired video signal format and outputting the converted transmission video signal data, wherein the signal processing is performed in synchronization with frame period timings generated on the basis of the frame reference signals inserted in the input transmission video signal data.

8. A video signal processing apparatus comprising:
a format converter configured to, upon receiving video signal data for which format switching can occur between a plurality of formats, convert the video signal data into transmission video signal data, the transmission video signal data being formatted such that the transmission video signal data is synchronized with clocks having a fixed frequency common to the plurality of formats and that the number of clocks corresponding to one frame determined according to the frequency of the clocks is the same regardless of the plurality of formats of the video signal data;
a frame reference signal insertion unit configured to insert a frame reference signal in each frame of the transmission video signal data obtained by the format converter to specify a predetermined reference data position in the frame;
a transmission output processor configured to transmit and output the transmission video signal data having the inserted frame reference signals in synchronization with the clocks on a frame-by-frame basis; and
a signal output processor configured to, upon receiving the transmission video signal data transmitted and output by the transmission output processor, perform signal processing for converting the transmission video signal data into a desired video signal format and outputting the converted transmission video signal data, wherein the signal processing is performed in synchronization with frame period timings generated on the basis of the frame reference signals inserted in the received transmission video signal.

9. A video signal processing apparatus comprising:
a format converter configured to, upon receiving video signal data for which format switching can occur between a plurality of formats, convert the video signal data into transmission video signal data, the transmission video signal data being formatted such that the transmission video signal data is synchronized with clocks having a fixed frequency common to the plurality of formats and that the number of clocks corresponding to one frame determined according to the frequency of the clocks is the same regardless of the plurality of formats of the video signal data;
a frame reference signal insertion unit configured to insert a frame reference signal in each frame of the transmission video signal data obtained by the format converter to specify a predetermined reference data position in the frame;
a transmission output processor configured to transmit and output the transmission video signal data having the inserted frame reference signals to another apparatus in synchronization with the clocks on a frame-by-frame basis.

10. A video signal processing apparatus comprising:
an input unit configured to input transmission video signal data transmitted and output from another apparatus, the transmission video signal data being generated by converting video signal data for which format switching can occur between a plurality of formats so as to be synchronized with clocks having a fixed frequency common to the plurality of formats and so that the number of clocks corresponding to one frame determined according to the frequency of the clocks is the same regardless of the plurality of formats of the video signal data, the transmission video signal data having a frame reference signal inserted in each frame thereof to specify a predetermined reference data position in the frame; and
a signal output processor configured to perform signal processing for converting the transmission video signal data input by the input unit into a desired video signal format and outputting the converted transmission video signal data, wherein the signal processing is performed in synchronization with frame period timings generated on the basis of the frame reference signals inserted in the input transmission video signal data.
